(19) United States
(12) Patent Application Publication
(10) Pub. No.: US 2026/0005279 A1
(43) Pub. Date: Jan. 1, 2026

(54) SEAL ARRANGEMENT AND PLATE STACK ARRANGEMENT

(71) Applicant: EKPO Fuel Cell Technologies GmbH, Dettingen (DE)

(72) Inventors: Stefan DWENGER, Dettingen (DE); Michael SCHAICH, Dettingen (DE); Joachim SCHERER, Dettingen (DE); Jens HEIN, Dettingen (DE); Martin NEDELE, Dettingen (DE); Simon SCHEU, Dettingen (DE)

(73) Assignee: EKPO Fuel Cell Technologies GmbH, Dettingen (DE)

(21) Appl. No.: 19/328,492

(22) Filed: Sep. 15, 2025

Related U.S. Application Data
(63) Continuation of application No. PCT/EP2024/057202, filed on Mar. 18, 2024.

(30) Foreign Application Priority Data
Mar. 20, 2023 (DE) 10 2023 106 909.8
Jul. 20, 2023 (DE) 20 2023 104 068.3

(51) Int. Cl. H01M 8/248

(52) U.S. Cl. CPC H01M 8/248

(57) ABSTRACT

A seal arrangement for sealing a space in a plate stack arrangement, wherein the plate stack arrangement can be, for example, a fuel cell stack or part of a fuel cell stack, and the space can be a space lying therein, wherein the seal arrangement comprises the following: a seal element for delimiting the space in at least one direction, and a compression protection unit for protecting the seal element in relation to irreversible deformation during compression of the plate stack arrangement along a plate stack longitudinal axis.

### RELATED APPLICATION

This application is a continuation of international application No. PCT/EP2024/057202 filed on Mar. 18, 2024, and claims the benefit of German applications No. 10 2023 106 909.8 filed on Mar. 20, 2023, and No. 10 2023 106 909.8 filed on Jul. 20, 2023, which are incorporated herein by reference in their entirety and for all purposes.

### FIELD OF DISCLOSURE

The present invention relates to the field of fuel cell technology. The present invention relates in particular to plate stack arrangements, e.g. in the form of a fuel cell stack, which can particularly well withstand the influences of high forces.

### BACKGROUND

Documents US 2020/0388858 A1, WO 2019/076813 A1, US 2021/0194019 A1 and US 2022/0037680 A1 likewise relate to the field of fuel cell technology. The teaching described therein however does not offer completely satisfactory solutions, in particular in the event of the influence of high forces which can arise in vehicles by heavy deceleration, e.g. in the event of accidents. The same applies to stationary applications, e.g. to forces acting during earthquakes.

### SUMMARY OF THE INVENTION

The present invention is based on the object of providing a plate stack arrangement, e.g. in the form of a fuel cell stack, which is easy to produce and durable and safe even under the influence of high forces, and of providing components therefor. In particular, they are to particularly well withstand forces acting along the plate stack longitudinal axis.

This object is achieved according to the invention by a seal arrangement as claimed in the respective independent patent claim.

The seal arrangement is a seal arrangement for sealing a space in a plate stack arrangement.

The plate stack arrangement can be any plate stack arrangement in which there is a requirement for sealing a space in the plate stack arrangement.

The plate stack arrangement can preferably be a fuel cell stack, part of a fuel cell stack, an electrolyte cell stack, part of an electrolyte cell stack, a thermal transfer plate stack, or part of a thermal transfer plate stack.

As is known, electrolyte cell stacks are installed in electrolyzers which serve in particular for the electrochemical decomposition of water into hydrogen and oxygen. As is known, thermal transfer plate stacks are installed in plate thermal transfer units which are colloquially also often referred to as plate heat exchangers or plate coolers.

The plate stack arrangement can be, for example, a fuel cell stack or part of a fuel cell stack.

The space can be a space which lies in the fuel cell stack or part of the fuel cell stack, in the electrolyte cell stack or part of the electrolyte cell stack, in the thermal transfer plate stack or part of the thermal transfer plate stack.

The plate stack arrangement can be, for example, a fuel cell stack or part of a fuel cell stack, and the space can be a space lying therein.

The seal arrangement can comprise in particular:
a seal element for delimiting the space in at least one direction, and
a compression protection unit for protecting the seal element in relation to irreversible deformation during compression of the plate stack arrangement along a plate stack longitudinal axis.

Besides this compression protection unit, the seal arrangement can of course comprise a further compression protection unit or a plurality of further compression protection units.

In the context of this description and the appendant claims, the term “in particular” is preferably used to describe optional features.

The seal element can be particularly suitable for delimiting the space in at least one direction. It can be advantageous when the seal element can surround the space or part of the space.

The space can in particular be a plate intermediate space which lies between plates of the plate stack arrangement.

The seal element can surround the space in particular when the space is the plate intermediate space.

The space can be a conduit space extending through at least one plate of the plate stack arrangement. The conduit space can extend, for example, through at least one conduit opening of at least one plate of the plate stack arrangement.

When the space is the conduit space, the seal element can surround part of the conduit space, for example in an annular manner.

It can be advantageous when the seal arrangement comprises a first seal element and a second seal element, wherein the first seal element can surround a plate intermediate space, and the second seal element can surround at least part of a conduit space.

The second seal element can be disposed between the plate intermediate space and the conduit space and can separate the plate intermediate space entirely or partially from the conduit space. The second seal element can have at least one passage by way of which a fluidic connection between the plate intermediate space and the conduit space is able to be generated, or exists.

The compression protection unit comprised by the seal arrangement is a compression protection unit for protecting the seal element in relation to irreversible deformation during compression of the plate stack arrangement along a plate stack longitudinal axis.

When the seal arrangement comprises the first seal element and the second seal element, the compression protection unit is in particular a compression protection unit for protecting the first seal element and the second seal element in relation to irreversible deformation during compression of the plate stack arrangement along the plate stack longitudinal axis.

When reference herein is made to “a seal element” or “the seal element”, this may for example refer to the first and/or the second seal element, in each case independently of one another.

The seal element can preferably be a seal element which is able to be reversibly deformed during a comparatively weak compression of the plate stack arrangement along the plate stack longitudinal axis, and is able to be irreversibly deformed during a comparatively strong compression of the plate stack arrangement along the plate stack longitudinal axis.

During compression of the plate stack arrangement along the plate stack longitudinal axis, the seal element within the plate stack arrangement can be compressed in the direction of the plate stack longitudinal axis. During strong compression of the plate stack arrangement along the plate stack longitudinal axis, the seal element can be strongly compressed along the plate stack longitudinal axis.

During the regular operation of a device, e.g. of a motor vehicle, in which the plate stack arrangement is installed, only minor forces arise along the plate stack longitudinal axis, such that the seal element is compressed to only a relatively minor degree. The seal element can typically be reversibly deformed in the process.

When the device, e.g. the motor vehicle, in which the plate stack arrangement is installed, is exposed to particularly high acceleration or deceleration, e.g. in an accident, high forces or force components can act along the plate stack longitudinal axis. The compression of the plate stack arrangement along the plate stack longitudinal axis can be accordingly stronger, such that an irreversible deformation of the seal element can occur.

The compression protection unit can in particular be a compression protection unit for protecting the seal element in relation to irreversible deformation during compression of the plate stack arrangement along the plate stack longitudinal axis arising in an accident.

The compression protection unit can be a single compression protection unit. The single compression protection unit can have the effect of protecting the seal element in particular without a corresponding further compression protection (sub-) unit. The compression protection unit can rise from a plate plane of a plate of the plate stack arrangement in the direction toward an adjacent plate of the plate stack arrangement.

It is preferable when the compression protection unit has two compression protection sub-units. At least one of the two compression protection sub-units can, for example, rise from a plate plane of at least one plate in the direction toward the other compression protection sub-unit, or into the other compression protection sub-unit. The other compression protection sub-unit can, for example, rise from a plate plane of an adjacent plate.

Every seal element that can delimit the space in the at least one direction can be considered a seal element.

In particular, every seal element that can surround the space, or at least part of the space, can be considered a seal element.

Various seal elements and materials suitable for producing the latter are known to persons skilled in the art, said seal elements being suitable for sealing a space in a plate stack arrangement, for example the described plate intermediate space or the described conduit space.

It can be advantageous when the seal element has a seal corrugation.

The seal corrugation can be a perimeter corrugation. The perimeter corrugation can delimit the space, in particular the plate intermediate space, in relation to an environment of the plate stack arrangement.

The seal corrugation can be a port corrugation. The port corrugation can surround at least part of the conduit space. For example, the port corrugation can delimit at least part of the conduit space and delimit the latter in relation to a plate intermediate space, for example.

The seal corrugation is preferably formed from a plate of the plate stack arrangement.

For example, the seal corrugation can be formed from a separator plate of the fuel cell stack.

It can be advantageous when the seal element has two mutually facing seal corrugations. The two mutually facing seal corrugations can be formed from two adjacent plates of the plate stack arrangement.

Advantageously, one of the two seal corrugations can in each case be formed from one of the respective adjacent plates and rise from the respective plate plane of the respective plate in the direction toward the other seal corrugation. For example, one of the two seal corrugations can in each case be formed from one of the adjacent separator plates and rise from the respective plate plane of the separator plate in the direction toward the other seal corrugation.

A plane which is aligned orthogonally to the plate stack longitudinal axis and can extend, e.g. centrically through an associated plate, e.g. through connection zones in which two plate elements of one plate can be connected to one another, is in particular referred to as a plate plane.

It can be particularly advantageous when the compression protection unit has a first compression protection element and a second compression protection element.

It can be particularly advantageous when the compression protection unit has
a corrugation element; and/or
a multi-layer compression protection zone; and/or
an elevation element and a depression element, wherein part of an elevation of the elevation element is received in a depression of the depression element.

The compression protection unit can have the corrugation element. Alternatively or additionally, the compression protection unit can have the multi-layer compression protection zone. Alternatively or additionally, the compression protection unit can have the elevation element and the depression element, wherein part of an elevation of the elevation element is received in a depression of the depression element.

It can be advantageous when the compression protection unit has the corrugation element, and the corrugation element is formed from a or the plate off the plate stack arrangement. For example, the corrugation element can be formed from a or the separator plate of the fuel cell stack. The corrugation element can preferably be formed from that plate of the plate stack arrangement from which the seal corrugation, or at least one seal corrugation, is also formed.

At least one compression protection unit, or at least part, or at least a portion, of the at least one compression protection unit, is preferably disposed or formed in a peripheral zone. The peripheral zone extends from the seal element to a periphery. The periphery delimits the surface extent of a or the plate of the plate stack arrangement. In particular, the periphery can delimit the surface extent of the plate of the plate stack arrangement on which the at least one compression protection unit is disposed, or from which the at least one compression protection unit is formed.

The statement that a feature of the seal arrangement, e.g. a seal corrugation or a corrugation element, is formed from a plate or a separator plate, can in particular refer to the fact that the feature of the seal arrangement, e.g. the seal corrugation or the corrugation element, is formed from a plate element of the plate or of the separator plate.

As is explained in more detail herein, in particular in the context of the plate stack arrangement according to the invention, a plate, e.g. a separator plate, can have two plate elements which are indirectly or directly, e.g. directly, connected to one another.

The corrugation element can preferably form at least one of the two compression protection elements.

It is preferable when the corrugation element forms the first compression protection element and the second compression protection element.

The first compression protection element and the second compression protection element are preferably disposed in such a way that during compression of the plate stack arrangement along the plate stack longitudinal axis, compression of the first compression protection element sets in before compression of the second compression protection element.

It is preferable when the corrugation element has two flanks of different heights, and the higher flank forms the first compression protection element or extends up to the first compression protection element.

It is particularly preferable when the corrugation element has two flanks of different heights, and the higher flank forms the first compression protection element, or extends up to the first compression protection element, and the lower flank forms the second compression protection element, or extends up to the second compression protection element.

A more heavily raised zone of the corrugation element can preferably form the first compression protection element, and the less heavily raised zone of the corrugation element can form the second compression protection element. The more heavily raised zone can be more heavily raised from a plate plane of a plate than the less heavily raised zone. The plate can be that plate from which the corrugation element is formed or may be formed.

This can have the effect that during compression of the plate stack arrangement along the plate stack longitudinal axis, compression of the first compression protection element can set in before compression of the second compression protection element.

Advantageously, the first compression protection element and the second compression protection element can be formed in such a way that during compression of the plate stack arrangement along the plate stack longitudinal axis, compression of the second compression protection element requires a higher input of force and/or energy than compression of the first compression protection element.

The input of force required during compression of the respective compression protection element can be measured in that a force acting on the respective compression protection element along the plate stack longitudinal axis is increased until the compression of the respective compression protection element begins. For this purpose, a flat surface of a testing probe can be pressed onto a portion of the compression protection element with an increasing force.

The compression of the second compression protection element in this instance requires a higher input of force when compression of the second protection element begins after compression of the first compression protection element has begun, and a higher input of force is required at the beginning of the compression of the second compression protection element than at the beginning of the compression of the first compression protection element.

The compression of the second compression protection element can preferably require an input of force which is at least double, in particular at least four times, for example at least eight times, the input of force for compression of the first compression protection element.

The compression of the second compression protection element can preferably require an input of energy which is at least double, in particular at least four times, for example at least eight times, the input of energy for compression of the first compression protection element.

The input of energy required for the respective compression of one of the compression protection elements can be determined in that the input of force required for compression is integrated over the compression distance. The input of energy required for the compression of the first compression protection element can in particular be the input of energy required for the compression of the first compression protection element until compression of the second compression protection element sets in.

The input of energy required for compression of the second compression protection element can be the input of energy which is required for further compression of the second compression protection element once the compression of the first compression protection element has taken place.

It can be advantageous when the first compression protection element and the second compression protection element are formed and/or disposed in such a way that during compression of the plate stack arrangement along the plate stack longitudinal axis, compression of at least the first compression protection element sets in before any irreversible deformation of the seal element occurs.

It can be advantageous when during compression of the plate stack arrangement along the plate stack longitudinal axis, compression of the first and compression of the second compression protection element sets in before any irreversible deformation of the seal element occurs.

For persons skilled in the art, it is readily possible to establish the compression of the plate stack arrangement along the plate stack longitudinal axis proceeding from which an irreversible deformation of the seal element begins. For persons skilled in the art, it is also readily possible to adapt the height and the shape of a compression protection element to the seal element in such a way that compression of at least the first compression protection element sets in before any irreversible deformation of the seal element occurs, or that compression of the first and compression of the second compression protection element sets in before any irreversible deformation of the seal element occurs.

It can be preferable when the first compression protection element and the second compression protection element are designed in such a way that during compression of the plate stack arrangement along the plate stack longitudinal axis, any reversible deformation of the seal element sets in before compression of the two compression protection elements occurs.

It can be preferable when the corrugation element forms at least one of a plurality of compression protection elements, and an absorption material which is disposed on a surface of the corrugation element forms a further one of a plurality of compression protection elements.

It can be preferable when the corrugation element forms at least the first compression protection element, and an absorption material disposed on a surface of the corrugation element forms the second compression protection element.

It can be preferable when the corrugation element forms at least the second compression protection element, and an absorption material disposed on a surface of the corrugation element forms the first compression protection element.

The absorption material can be disposed on an inner surface of the corrugation element.

The absorption material can be disposed on an outer surface of the corrugation element.

It can be advantageous when the corrugation element forms a first one of a plurality of compression protection elements, for example forms the first compression protection element, and an absorption material disposed on an inner surface of the corrugation element forms a further one of a plurality of compression protection elements, in particular a second one of a plurality of compression protection elements, for example the second compression protection element.

It can be advantageous when the corrugation element forms at least one of the plurality of compression protection elements, in particular a second one of a plurality of compression protection elements, for example the second compression protection element, and an absorption material disposed on an outer surface of the corrugation element forms a first one of a plurality of compression protection elements, for example the first compression protection element.

The absorption material disposed on the inner surface of the corrugation element can occupy part of the depression of the corrugation element that leads to the inner surface of the corrugation element.

The absorption material disposed on the inner surface of the corrugation element can completely occupy a depression of the corrugation element that leads to the inner surface of the corrugation element.

The seal corrugation can have a plurality of walls. Two of the walls of the seal element preferably have different inclinations in relation to the plate stack longitudinal axis. It can be particularly preferable when two of the walls are inclined in opposite directions in relation to the plate stack longitudinal axis. It can be particularly preferable when two of the walls are inclined in opposite directions and to identical degrees in relation to the plate stack longitudinal axis. A third wall of the seal corrugation can connect the two further walls.

The two walls of the seal corrugation which have different inclinations in relation to the plate stack longitudinal axis can form flanks or legs of the seal corrugation. The flanks or legs of the seal corrugation can be connected by way of the third wall.

The third wall of the seal corrugation can be aligned orthogonally to the plate stack longitudinal axis.

The seal corrugation can be a full corrugation, or comprise a full corrugation.

The seal corrugation can be a half corrugation, or comprise a half corrugation.

The corrugation element can have a plurality of walls, preferably at least three walls. Two of the walls of the corrugation element can have different inclinations in relation to the plate stack longitudinal axis. These two walls of the corrugation element can be inclined in opposite directions in relation to the plate stack longitudinal axis. These two walls of the corrugation element can be inclined in opposite directions and to identical degrees in relation to the plate stack longitudinal axis. These two walls of the corrugation element can form flanks or legs of the corrugation element. A third wall of the corrugation element can connect the two flanks or legs.

It can be advantageous when the third wall of the corrugation element is not aligned orthogonally to the plate stack longitudinal axis.

It can be advantageous when a depression is formed in a wall of the corrugation element, for example in the third wall of the corrugation element. The depression can be formed in the same direction or in the opposite direction in relation to the corrugation element.

When the depression is formed in the same direction in relation to the corrugation element, this can mean in particular that an inner surface of the corrugation element transitions into an inner surface of the depression.

When the depression is formed in the opposite direction in relation to the corrugation element, the depression can extend so as to proceed from an outer surface of the corrugation element into the corrugation element.

It can be advantageous when the compression protection element is a compression protection component which is able to be incorporated between plates of a plate stack arrangement, the space potentially lying therebetween. The compression protection component can be a metal sheet, for example.

The compression protection component can be, for example
loosely insertable,
connected, or able to be connected, to a seal, e.g. in the form of a frame film,
   or
able to be fixedly established, or be fixedly established, on a plate surface of a plate of the plate stack arrangement.

The compression protection component can represent a second compression protection element described herein, which is preferably not compressible, or compressible only under an extremely high input of force.

It can be advantageous when
the seal element has at least one wider and at least one narrower seal element portion, wherein a width of the seal element in the wider seal element portion is larger than a width of the seal element in the narrower seal element portion;
   and/or
the compression protection unit has at least one wider and at least one narrower compression protection unit portion, wherein a width of the compression protection unit in the wider compression protection unit portion is larger than a width of the compression protection unit in the narrower compression protection unit portion;
   and/or
the seal element has at least one higher and at least one lower seal element portion, wherein a height of the seal element in the higher seal element portion is larger than a width of the seal element in the lower seal element portion;
   and/or
the compression protection unit has at least one higher and at least one lower compression protection unit portion, wherein a height of the compression protection unit in the higher compression protection unit portion is larger than a height of the compression protection unit in the lower compression protection unit portion.

A portion of the seal element is herein referred to as a seal element portion.

A portion of the compression protection unit is herein referred to as a compression protection unit portion.

Widths of the seal element or of the compression protection unit in the respective portion can in each case be measured orthogonally to the main direction of extent of the seal element or of the compression protection unit therein, and parallel to the respective plate plane, e.g. in the respective plate plane. The width can preferably be a width able to be measured on the base of the seal element or of the compression protection unit.

The height of the seal element or of the compression protection unit is in each case measured in the direction parallel to the plate stack longitudinal axis.

It can be advantageous when the compression protection unit has the multi-layer compression protection zone.

It can be particularly advantageous when the compression protection unit has the multi-layer compression protection zone, wherein at least one portion of the multi-layer compression protection zone is disposed or formed in the peripheral zone.

It can be preferable when the at least one portion of the multi-layer compression protection zone in the peripheral zone is at least partially formed from the plate or the plate element.

A first and a second layer of the multi-layer compression protection zone can preferably be formed by the same plate. Both layers can extend so as to proceed from a periphery delimiting the surface extent of the plate. It is preferable when the seal corrugation is formed from a first one of the two layers, and the second one of the two layers extends from the periphery in the direction toward the seal corrugation. Advantageously, the second layer, which extends from the periphery in the direction toward the seal corrugation, cannot reach as far as the seal corrugation.

It can be advantageous when the multi-layer compression protection zone of the compression protection unit has the first compression protection element and the second compression protection element.

It can be advantageous when a multi-layer compression protection zone is formed on one portion of the periphery, and no multi-layer compression protection zone is formed on another portion of the periphery.

It can be particularly advantageous when one portion of the multi-layer compression protection zone is wider than another portion of the multi-layer compression protection zone. It can be preferable when the second one of the layers in the wider portion of the multi-layer compression protection zone extends farther from the periphery in the direction toward the seal element than in the other portion of the multi-layer compression protection zone.

It can be preferable when the wider portion, or the other less wide portion, of the multi-layer compression protection zone forms the first compression protection element. For example, the wider portion of the multi-layer compression protection zone can form the first compression protection element, and the other, less wide portion of the multi-layer compression protection zone can form the second compression protection element. Alternatively, the wider portion of the multi-layer compression protection zone can form the second compression protection element, and the other, less wide portion of the multi-layer compression protection zone can form the first compression protection element.

A material can be disposed in the multi-layer compression protection zone. The material can be a filler material and/or an absorption material. The material, e.g. the filler material or the absorption material, can contain a plastics material, or be a plastics material. The material can have pores.

The material, e.g. the absorption material or the filler material, can be disposed between the first and the second layer of the multi-layer compression protection zone, or extend into a region of the multi-layer compression protection zone present between the first and the second layer of the multi-layer compression protection zone.

The first and the second layer of the multi-layer compression protection zone can be formed by the same plate, e.g. by flanging, wherein both layers extend so as to proceed from the periphery, e.g. the flanged periphery, that delimits the surface extent of the plate.

The first and the second layer of the multi-layer compression protection zone can be formed by the same plate element of the plate, e.g. by flanging, wherein both layers of the plate element extend so as to proceed from the periphery, e.g. the flanged periphery, that delimits the surface extent of the plate.

The described design possibilities for compression protection units with multi-layer compression protection zones, wherein a multi-layer compression protection zone is formed on one portion of the periphery, and no multi-layer compression protection zone is formed on another portion of the periphery, and/or wherein one portion of the multi-layer compression protection zone is wider than another portion of the multi-layer compression protection zone, prove advantageous in particular with a view to flanging, because the portions without a multi-layer compression protection zone, or with a narrower multi-layer compression protection zone, facilitate flanging. It has been demonstrated in particular that a distortion of plates, which may result due to flanging, can be particularly minor, and thus particularly precise plate stack arrangements with reliable sealing of spaces therein can ultimately be obtained.

It can be particularly advantageous when the two layers extend so as to proceed from the periphery that delimits the surface extent of the plate, wherein at least one portion of one of the two layers is inclined in relation to another portion of the other one of the two layers. The mutual inclination angle which the two layers enclose in these two portions can be, for example, at least 5°, in particular at least 8°, e.g. at least 12°. The mutual inclination angle which the two layers enclose in these two portions can be, for example, at most 70°, in particular at most 60°, e.g. at most 45°.

A first compression protection element can be formed where the two layers are farthest apart. The second compression protection element can be formed where the two layers have a smaller spacing.

At least one of the two layers can be coated. At least one of the two layers can preferably be coated on a surface that faces the other layer. The coating can be applied prior to flanging.

Both layers can be coated. The two layers can be coated on mutually facing surfaces.

At least one of the two layers can be coated on both sides.

Both layers can be coated on both sides.

A thickness of the multi-layer compression protection zone can be adjusted in a targeted manner by adjusting the thickness of the coatings in a targeted manner, and by a targeted selection of a number of coatings. In particular, the thickness can be adjusted in a targeted manner in such a way that during compression of the plate stack arrangement along the plate stack longitudinal axis, any irreversible deformation of the seal element is reliably prevented in that the regions in which multi-layer compression protection zones of adjacent plates are present abut one another before any irreversible deformation of the seal element can set in.

It can be advantageous when the compression protection unit has the elevation element and the depression element, wherein part of an elevation of the elevation element is received in a depression of the depression element.

The elevation element and the depression element can in each case be a corrugation element.

The depression element can be a depression element of both plate elements of one plate, in which the two plate elements of one plate can be bent in the same direction.

The elevation element, proceeding from an adjacent plate, can rise into the depression element.

It can be preferable,
when an elevation height of the elevation is larger than a depression depth of the depression
   and/or
when flanks of the elevation in the depression are spaced apart from flanks of the depression, wherein the flanks of the elevation in the depression can be spaced apart from flanks of the depression, for example, in such a way that the flanks of the elevation can spread toward the flanks of the depression.

It can be particularly preferable when the elevation height of the elevation is larger than the depression depth of the depression, and when flanks of the elevation in the depression are spaced apart from flanks of the depression.

As a result, it can be enabled, for example, that during compression of the plate stack arrangement along a plate stack longitudinal axis, the compression protection unit prevents an irreversible deformation of the seal element in a particularly efficient manner. When such compression takes place along the plate stack longitudinal axis, the elevation can move into the depression. Moreover, the flanks of the elevation can spread in the depression, such that an additional spring effect can evolve, the latter being able to protect the seal element in relation to irreversible deformation.

In particular, part of the force acting along the plate stack longitudinal axis, which may lead to irreversible deformation of the seal element, can ultimately cause the flanks of the elevation element received in the depression to spread instead.

It can be advantageous when the compression protection unit defines a first elevation zone and a second elevation zone, wherein the compression protection unit in the first elevation zone and in the second elevation zone is raised in the direction of the plate stack longitudinal axis in comparison to a base portion of the seal arrangement, wherein the base portion can preferably lie between the seal element and the compression protection unit.

It is preferable when the compression protection unit has the corrugation element, and the corrugation element defines at least one of the two elevation zones, wherein a further corrugation element, or the same corrugation element, can define a further one of the two elevation zones.

The compression protection unit can have the corrugation element, and the corrugation element can define one of the two elevation zones, wherein a further corrugation element can define a further one of the two elevation zones.

The compression protection unit can have the corrugation element, and the corrugation element can define the one of the two elevation zones and the other one of the two elevation zones.

For example, a first portion of a corrugation element can define one of the two elevation zones, and a further portion of the same corrugation element can define the other one of the two elevation zones.

It can be advantageous when the compression protection unit has a plateau zone which is raised in comparison to a base portion of the seal arrangement. The plateau zone can preferably be formed by elevation zones that transition into one another. For example, the elevation zones can transition continuously into one another, thus forming a plateau zone which extends continuously across a plurality of elevation zones.

The compression protection unit can have one or a plurality of further plateau zones next to this plateau zone. The plateau zone, or plateau zones, can preferably occupy 5 to 95%, particularly preferably 10 to 85%, of the peripheral zone, e.g. 20 to 75% of the peripheral zone. Recessed intermediate portions which may optionally be present are added to the surface of the respective plateau zone.

It can be advantageous when the compression protection unit has an intermediate portion between the first elevation zone and the second elevation zone. It can be advantageous when the plateau zone extends about an intermediate portion recessed into the plateau zone.

The recessed intermediate portion can have any shape. It can have a larger extent in one direction of extent of the seal element than transversely to this direction of extent in the direction from the seal element to the periphery.

It is preferable when the recessed intermediate portion bends in alternation in one direction and in the direction counter to the latter along a direction of extent of the intermediate portion.

The recessed intermediate portion can optionally extend straight between the alternating bends.

The recessed intermediate portion can preferably meander in the plateau zone.

The plateau zone can preferably extend about a plurality of intermediate portions recessed into the plateau zone. The plateau zone can preferably have at least 4, particularly preferably at least 6, e.g. at least 10, recessed intermediate portions.

In the intermediate portion, the compression protection unit may not be raised in the direction of the plate stack longitudinal axis in comparison to the base portion. Alternatively, the intermediate portion can define an intermediate elevation zone in which the intermediate portion is raised in the direction of the plate stack longitudinal axis in comparison to the base portion, wherein the compression protection unit in the first elevation zone and in the second elevation zone is in each case more raised in the direction of the plate stack longitudinal axis than the intermediate portion, or wherein the compression protection unit in the plateau zone is more raised in the direction of the plate stack longitudinal axis than the intermediate portion recessed into the plateau zone, or than the intermediate portions recessed into the plateau zone.

Preferably, an intermediate height of the compression protection unit, able to be measured proceeding from the intermediate portion in the direction of the plate stack longitudinal axis, on the first or the second elevation zone is 10% to 99.8%, preferably 50% to 99%, furthermore preferably 65% to 98.5%, e.g. 75% to 98%, of a base height of the compression protection unit, able to be measured proceeding from the base portion in the direction of the plate stack longitudinal axis, on the same elevation zone.

It can be advantageous when the corrugation element has flanks of different heights, or the corrugation elements have flanks of different heights, or the plateau zone has flanks of different heights, wherein the number of flanks is preferably at least four, wherein it is preferable when a higher flank, which extends so as to proceed from the base portion, is of a flatter inclination than a flank of lesser height, which extends so as to proceed from the intermediate portion, wherein a smaller inclination angle of the higher flank of flatter inclination can preferably be 15° to 70°, and a larger inclination angle of the flank of lesser height and steeper inclination can preferably be 20° to 90°. The larger inclination angle of the flank of steeper inclination and lesser height can be at least 5°, preferably at least 7°, particularly preferably at least 9°, larger than the smaller inclination angle of the higher flank of flatter inclination.

When reference is made herein to an inclination angle of a flank, this refers to an angle in relation to a plane, e.g. a plate plane, aligned orthogonally to the plate stack longitudinal axis.

The inclination angle of a flank can preferably be measured where the respective flank has its greatest inclination.

A compression protection unit direction of extent, along which at least one part of a compression protection unit extends, can have in relation to a seal element direction of extent, along which a part of the seal element that is directly adjacent to the at least one part of the compression protection unit extends, an angle of extent in a range from 5° to 85°, e.g. 20° to 70°.

It can be advantageous when the compression protection unit has a first compression protection element and a second compression protection element, and the two compression protection elements are disposed or formed in the peripheral zone, wherein at least a first one of the compression protection elements is disposed or formed completely in a peripheral zone portion of the peripheral zone, wherein the peripheral zone portion extends in the radial direction from the seal element up to the periphery, and the peripheral zone portion extends along a peripheral direction of extent over a length of at most 15% of the peripheral length, wherein the peripheral length is a length of the periphery.

It is preferable when at least one of the compression protection elements is formed to be encircling in an annular manner within the peripheral zone portion.

Alternatively, at least one of the compression protection elements can be formed to be encircling in a helical manner within the peripheral zone portion.

The radial direction herein can in particular refer to a direction from the seal element toward the periphery. The radial direction can in particular extend from the seal element toward the periphery in such a way that the direction extends orthogonally to the periphery.

For example, the radial direction can extend orthogonally to the peripheral direction of extent.

It can be advantageous when at least one compression protection element is in each case disposed or formed in a plurality of successive peripheral zone portions along the peripheral direction of extent.

A compression protection element which extends from a peripheral zone portion at least into an adjacent peripheral zone portion, or through the adjacent peripheral zone portion, can be disposed or formed here.

For example, the compression protection element therein can be formed to be encircling in an annular or helical manner.

It is preferable when a compression protection element extent of at least one of the compression protection elements, able to be measured in the direction of the peripheral direction of extent, is larger than a compression protection element spacing of two adjacent compression protection elements, able to be measured in the direction of the peripheral direction of extent, that are disposed or formed in successive peripheral zone portions.

Preferably, the ratio of compression protection element extent to compression protection element spacing can be in a range from 10:9 to 20:1, particularly preferably in a range from 10:8 to 10:1.

It can be particularly advantageous when the compression protection element extent is larger than the compression protection element spacing, because compression protection elements that are formed at two interconnected plate elements, or compression protection elements of adjacent plates, in a plate stack arrangement can in this instance be in each case aligned in such a way that a directly adjacent compression protection element in the direction of the plate stack longitudinal axis can bridge a compression protection element spacing of two compression protection elements disposed next to one another orthogonally to the plate stack longitudinal axis. This can facilitate an elastic deformation during compression of the plate stack arrangement along a plate stack longitudinal axis, and thus contribute toward a durability of a plate stack arrangement.

It can be advantageous when at least two compression protection elements are disposed or formed in the peripheral zone, wherein a first one of the at least two compression protection elements in the peripheral zone is farther from the periphery than a second one of the at least two compression protection elements.

It is preferable when
an outer end of the compression protection element lying in the peripheral zone so as to be farther from the periphery lies farther from the periphery than an inner end of the second one of the at least two compression protection elements;
   and/or
one compression protection element is in each case disposed or formed on the inside in the peripheral zone in a plurality of successive peripheral zone portions along the peripheral direction of extent, and another compression protection element is disposed or formed on the outside in the peripheral zone;
   and/or
the peripheral zone comprises an outer peripheral zone which is closer to the periphery, and an inner peripheral zone which is farther from the periphery, a plurality of compression protection elements which are adjacent in the direction of the peripheral direction of extent being disposed or formed in the outer peripheral zone, and a plurality of compression protection elements which are adjacent in the direction of the peripheral direction of extent being disposed or formed in the inner peripheral zone.

It is particularly preferable when at least one of the compression protection elements is a corrugation element, preferably a plurality of the compression protection elements are corrugation elements, e.g. all compression protection elements are corrugation elements.

It can be advantageous when, in comparison to the base portion of the seal arrangement, the compression protection unit in the first elevation zone is raised to a lesser degree in the direction of the plate stack longitudinal axis than in the second elevation zone, wherein the base portion can preferably lie between the seal element and the compression protection unit.

It is preferable when the first elevation zone is an elevation zone of the first one of the at least two compression protection elements, and the second elevation zone is an elevation zone of the second one of the at least two compression protection elements, and the first one of the at least two compression protection elements in the peripheral zone is farther from the periphery than the second one of the at least two compression protection elements, wherein at least the first one of the at least two compression protection elements is a corrugation element, and at least the second one of the at least two compression protection elements is a corrugation element.

It is preferable when one of the compression protection elements, for example the second one of the compression protection elements, has a flank of flatter inclination, and one of the compression protection elements, for example the first one of the compression protection elements, has a flank of steeper inclination.

A smaller inclination angle of the flank of flatter inclination can preferably be 15° to 70°. A larger inclination angle of the flank of steeper inclination can preferably be 20° to 90°.

It can be advantageous when the first elevation zone is a body elevation zone, and the second elevation zone is a head elevation zone adjoining the body elevation zone in the direction of the plate stack longitudinal axis.

It is preferable when a flank of the head elevation zone has a flatter inclination than a flank of the body elevation zone.

It is particularly preferable when a smaller inclination angle of a flank of flatter inclination of the head elevation zone is 15° to 70°, and a larger inclination angle of a flank of steeper inclination of the body elevation zone is 20° to 90°.

It can be advantageous when the compression protection unit has at least one higher and at least one lower compression protection unit portion, wherein a height of the compression protection unit in the higher compression protection unit portion is larger than a height of the compression protection unit in the lower compression protection unit portion.

It is preferable when the compression protection unit has a head elevation zone only in the higher compression protection unit portion.

It can be advantageous when a degree of bending of the compression protection unit, e.g. of a corrugation element of the compression protection unit, along a direction of extent of the compression protection unit, increases and decreases in alternation.

It is preferable when the compression protection unit, e.g. the corrugation element of the compression protection unit, bends in alternation in one direction and in the direction counter to the latter along a direction of extent of the compression protection unit.

The compression protection unit, e.g. the corrugation element of the compression protection unit, can optionally extend rectilinearly between the alternating bends.

The compression protection unit, e.g. the corrugation element of the compression protection unit, can preferably meander in the peripheral zone.

It can be advantageous when
the compression protection unit has the elevation element and the depression element, wherein part of an elevation of the elevation element is received in a depression of the depression element;
   and/or
the compression protection unit has an elevation element and a depression element, wherein part of an elevation of the elevation element is able to be received in a depression of the depression element when a deformation of the compression protection unit occurs during compression of the plate stack arrangement along a plate stack longitudinal axis.

It can be advantageous when the compression protection unit has a plurality of elevation elements and of depression elements, wherein part of an elevation of each elevation element is in each case received in a corresponding depression of at least one depression element, or is in each case able to be received in a corresponding depression of at least one depression element, when a deformation of the compression protection unit occurs during compression of the plate stack arrangement along a plate stack longitudinal axis.

It can be advantageous when at least part of the elevation element and at least part of the depression element are formed between corrugation elements.

It is preferable when the elevation element is an elevation element formed from a first plate element of a plate, and the depression element is a depression element formed from a second plate element of a plate.

The object is achieved according to the invention by the plate stack assembly as claimed in the respective independent claim.

The plate stack arrangement can preferably be a fuel cell stack or part of a fuel cell stack. The plate stack arrangement can be, for example, a fuel cell stack.

Alternatively, the plate stack arrangement can be an electrolyte cell stack, or part of an electrolyte cell stack, or a thermal transfer plate stack, or part of a thermal transfer plate stack.

The plate stack arrangement can be a plate stack arrangement for a motor vehicle, for example a fuel cell stack for a motor vehicle. The motor vehicle can in particular be a road vehicle, a rail vehicle or an aircraft, e.g. a road vehicle.

The plate stack arrangement can in particular comprise the following:
a plurality of plates,
a space in the plate stack arrangement, and
a seal arrangement which is described herein and the seal element thereof delimiting the space in at least one direction.

The plate stack arrangement can be, for example, a fuel cell stack or part of a fuel cell stack, and the space can be a space lying therein.

The plurality of plates can be, for example, a plurality of separator plates.

The space can in particular be the plate intermediate space which lies between the plates of the plate stack arrangement.

The seal element can surround the space in particular when the space is the plate intermediate space.

The plate intermediate space can extend between two plates which are adjacent in the plate stack arrangement. The plate intermediate space can extend, for example, between two adjacent separator plates of the fuel cell stack.

It is known to persons skilled in the art that the space, which can extend between two adjacent separator plates of the fuel cell stack, in a customary fuel cell stack can be divided, e.g. by membrane-electrode units, or membrane-electrode assemblies (MEA), into a cathode space for guiding a cathode gas and into an anode space for guiding an anode gas. This is an obvious fact known to persons skilled in the art, which will therefore not be discussed in more detail in the context of the present invention.

The space can be the conduit space which extends through at least one plate of the plate stack arrangement. The conduit space can extend, for example, through at least one conduit opening of at least one plate of the plate stack arrangement.

When the space is the conduit space, the seal element can surround, e.g. in an annular manner, part of the conduit space.

It is preferable when the seal element has two mutually facing seal corrugations, and one of the two seal corrugations is in each case formed from one of two respective adjacent plates, e.g. separator plates, and rises from the respective plate plane of the respective plate, e.g. of the separator plate, in the direction toward the other seal corrugation.

An insulation can be disposed between the seal corrugations. This insulation prevents shorting. Shorting can arise when there is direct contact between adjacent plates.

It can be advantageous when the compression protection unit is disposed on an inlet zone or an outlet zone, or reaches up to the inlet zone or the outlet zone.

The inlet zone can be an anode gas inlet zone provided for introducing an anode gas into the anode space.

The inlet zone can be a cathode gas inlet zone provided for introducing a cathode gas into the cathode space.

The outlet zone can be an anode gas outlet zone provided for discharging a completely or partially spent anode gas from the anode space.

The outlet zone can be a cathode gas outlet zone provided for discharging a completely or partially spent cathode gas from the cathode space.

This can contribute decisively toward increasing the durability and safety of a plate stack arrangement under the influence of high forces. This is because the fluid-conducting structures present in the region of the inlet zone and/or outlet zone are exposed to lower forces acting thereon than in the absence of any compression protection.

It can be advantageous when the stiffness of a compression protection unit on the inlet zone and/or on the outlet zone is higher than the stiffness of said compression protection unit, or of another compression protection unit, in a region of the plate stack arrangement that is spaced apart from all inlet zones and outlet zones.

For example, a compression of the compression protection unit on the inlet zone and/or on the outlet zone can require a higher input of force and/or energy than the compression of the same or of another compression protection unit in the region of the plate stack arrangement that is spaced apart from all inlet zones and outlet zones.

It is preferable when the compression protection unit has two compression protection sub-units. At least one of the two compression protection sub-units can rise from a plate plane of at least one of the two plates, e.g. at least one of the two separator plates, in the direction toward the other compression protection sub-unit, or into the other compression protection sub-unit. At least one of the two compression protection sub-units can be formed from one of two adjacent plates, e.g. separator plates. At least one of the two compression protection sub-units can be disposed on one of two adjacent plates. It is preferable when
at least one compression protection sub-unit has a corrugation element; and/or
at least one of the compression protection sub-units has a plateau zone; and/or
at least one compression protection sub-unit has a multi-layer compression protection zone; and/or one of the compression protection sub-units has an elevation element and the other of the compression protection sub-units has a depression element, wherein part of an elevation of the elevation element is received in a depression of the depression element.

The two compression protection sub-units can be formed and/or disposed in such a way that they can move toward one another during compression of the plate stack arrangement along the plate stack longitudinal axis.

It can be advantageous when one of the two compression protection sub-units is in each case formed from one of the two respective adjacent plates, e.g. separator plates, and both compression protection sub-units rise in the direction toward the respective other compression protection sub-unit, wherein it is preferable when
both compression protection sub-units have in each case a corrugation element; and/or
both compression protection sub-units have in each case a multi-layer compression protection zone.

Preferably, one of the two compression protection sub-units can rise from the at least one plate plane of the at least one plate, e.g. of the at least one separator plate, into the other compression protection sub-unit, wherein it is preferable when one of the compression protection sub-units has an elevation element, and the other of the compression protection sub-units has a depression element, wherein part of an elevation of the elevation element is received in a depression of the depression element.

It can be particularly advantageous when the plate stack arrangement, e.g. the fuel cell stack, comprises the following:
a further space in the plate arrangement, and
a further seal arrangement, the seal element of the latter delimiting the further space in at least one direction, wherein the further seal arrangement can preferably be a further seal arrangement described herein.

It is preferable when both spaces are plate intermediate spaces which extend in each case between two plates which are adjacent in the plate stack arrangement. It is preferable when only one of the plates lies between the two plate intermediate spaces.

It is preferable when at least one plate of the plate stack arrangement, e.g. at least one separator plate of the fuel cell stack, has two plate elements which are connected indirectly or directly to one another, wherein a main surface of the one plate element faces a main surface of the other plate element.

The interconnected plate elements are preferably connected directly to one another.

The interconnected plate elements are preferably welded to one another in welding zones.

The interconnected plate elements are preferably connected to one another in an electrically conducting manner.

Preferably, the at least one plate of the plate stack arrangement is a metal plate, e.g. at least one metal separator plate. The two interconnected plate elements are preferably metal plate elements.

It is particularly preferable when an indirect or direct connection of the plate elements in the peripheral zone of a seal arrangement is
between the seal element and the compression protection unit of the seal arrangement
   and/or
between the compression protection unit and the periphery
   and/or
within the compression protection unit, e.g. between different compression protection elements, different elevation zones, different compression protection unit portions, or different corrugation elements.

For example, an indirect or direct connection of the plate elements in the peripheral zone of the seal arrangement can be between the seal element and the compression protection unit of the seal arrangement, and a further indirect or direct connection of the plate elements in the peripheral zone of the seal arrangement can be between the compression protection unit and the periphery.

Preferably, the further seal arrangement can also be a further seal arrangement described herein, wherein at least one first compression protection unit portion of the one compression protection unit overlaps a first compression protection unit portion of the further compression protection unit. It is preferable when at least one second compression protection unit portion of the one compression protection unit does not overlap a second compression protection unit portion of the further compression protection unit.

The at least one first compression protection unit portion of the one compression protection unit can overlap the first compression protection unit portion of the further compression protection unit in an overlap zone.

When a compression protection unit portion of the one compression protection unit overlaps a first compression protection unit portion of the further compression protection unit, this can mean in particular that a straight line, which is aligned parallel to the plate stack longitudinal axis, extends through the two overlapping portions where the portions overlap, e.g. in the overlap zone.

Preferably, the two compression protection unit portions of the one compression protection unit are formed from the one of the interconnected plate elements, and the two compression protection unit portions of the further compression protection unit are formed from the other of the interconnected plate elements.

One compression protection unit portion can transition directly, e.g. seamlessly, into another compression protection unit portion of the same compression protection unit. Portions of the same compression protection unit may for example differ from one another solely in that only one of the portions is overlapped or disposed in an overlap zone.

It can be particularly advantageous when there is an indirect or direct connection of the plate elements between two overlap zones which are mutually offset in the plate plane, wherein different compression protection units or compression protection unit portions of different compression protection units formed in each case from one of the two plate elements overlap one another in the overlap zones. Alternatively or additionally, the indirect or direct connection of the plate elements can be at least partially surrounded by at least one compression protection unit or one compression protection unit portion, wherein the compression protection unit or the compression protection unit portion can be formed from at least one of the plate elements.

It can be particularly advantageous when a spacing of a compression protection unit from a nearest location at which there is an indirect or direct connection of the plate elements is at most 200% of a greatest extent of the compression protection unit in the direction of the plate stack longitudinal axis, wherein a spacing of a corrugation element, elevation element or depression element formed from at least one of the plate elements from a nearest location at which there is an indirect or direct connection of the plate elements can be at most 200% of the depth of the depression element, or at most 200% of the height of the corrugation element or of the elevation element.

The value of at most 200% herein can preferably be at most 160%, particularly preferably at most 130%, e.g. at most 115%.

Of course, features described in the context of one subject matter according to the invention can also be features of another subject matter according to the invention. Subject matter according to the invention includes in particular the seal arrangement and the plate stack arrangement.

Further preferred features and/or advantages of the invention are the subject matter of the description hereunder and of the illustration of exemplary embodiments in the drawings.

### BRIEF DESCRIPTION OF THE DRAWINGS

FIG. 1: shows a view from above onto a plate, in a schematic illustration;

FIG. 2: shows a view from above onto a further plate, in a schematic illustration;

FIG. 3: shows a view from above onto a further plate, in a schematic illustration;

FIG. 4: shows a portion of a section through a plate, in a schematic illustration;

FIG. 5: shows a portion of a section through a plate, in a schematic illustration;

FIG. 6: shows a portion of a section through a plate, in a schematic illustration;

FIG. 7: shows a view from above onto a portion of a plate, in a schematic illustration;

FIG. 8: shows a portion of a section through a plate, in a schematic illustration;

FIG. 9: shows a portion of a section through a plate, in a schematic illustration;

FIG. 10: shows a schematic illustration of a peripheral zone of a plate;

FIG. 11: shows a schematic illustration of a peripheral zone of a plate;

FIG. 12: shows a schematic illustration of a peripheral zone of a plate;

FIG. 13: shows a portion of a section through a plate, in a schematic illustration;

FIG. 14: shows a fragment of a plate, in a schematic illustration;

FIG. 15: shows a portion of a section through a plate, in a schematic illustration;

FIG. 16: shows a portion of a section through a plate, in a schematic illustration;

FIG. 17: shows a portion of a section through a plate, in a schematic illustration;

FIG. 18: shows a step for adapting a corrugation precursor element;

FIG. 19: shows an illustration of elevation and depression elements lying on top of one another;

FIG. 20: shows a section through peripheral regions of plates, which have an elevation element and/or a depression element;

FIG. 21: shows a fragment of a plate stack arrangement, in a schematic illustration, before compression along the stack longitudinal axis;

FIG. 22: shoes the fragment from FIG. 21 during compression along the stack longitudinal axis;

FIG. 23: shows the fragment from FIGS. 21 and 22 after compression along the stack longitudinal axis;

FIG. 24: shows a fragment of a plate stack arrangement, in a schematic illustration, before compression along the stack longitudinal axis;

FIG. 25: shows the fragment from FIG. 24 during compression along the stack longitudinal axis;

FIG. 26: shows the fragment from FIGS. 24 and 25 after compression along the stack longitudinal axis;

FIG. 27: shows a fragment of a plate, wherein two seal elements and one compression protection unit are provided for the seal arrangement;

FIG. 28: shows a portion of a section through a plate, in a schematic illustration;

FIG. 29: shows a portion of a section through a plate, in a schematic illustration;

FIG. 30: shows a schematic illustration of a peripheral zone of a plate;

FIG. 31: shows a schematic illustration of a peripheral zone of a plate;

FIG. 32: shows a schematic illustration of a peripheral zone of a plate;

FIG. 33: shows a portion of a section through a plate, in a schematic illustration;

FIG. 34: shows a schematic illustration of a peripheral zone of a plate;

FIG. 35: shows a portion of a section through a plate, in a schematic illustration;

FIG. 36: shows a portion of a section through a plate, in a schematic illustration;

FIG. 37: shows a schematic illustration of a peripheral zone of a plate;

FIG. 38: shows the section A-A through FIG. 37;

FIG. 39: shows the section B-B through FIG. 37;

FIG. 40: shows a schematic illustration of a compression protection unit;

FIG. 41: shows a section through the compression protection unit from FIG. 40;

FIG. 42: shows a schematic illustration of a compression protection unit;

FIG. 43: shows a section through the compression protection unit from FIG. 42;

FIG. 44: shows a schematic illustration of a compression protection unit;

FIG. 45: shows a section through the compression protection unit from FIG. 44;

FIG. 46: shows a schematic illustration of a compression protection unit;

FIG. 47: shows a section through the compression protection unit from FIG. 46;

FIG. 48: shows a schematic illustration of a compression protection unit;

FIG. 49: shows a section through the compression protection unit from FIG. 48;

FIG. 50: shows a schematic illustration of a compression protection unit; and

FIG. 51: shows a section through the compression protection unit from FIG. 50.

Identical or functionally equivalent elements are denoted by the same reference signs in all of the figures.

### DETAILED DESCRIPTION OF THE DRAWINGS

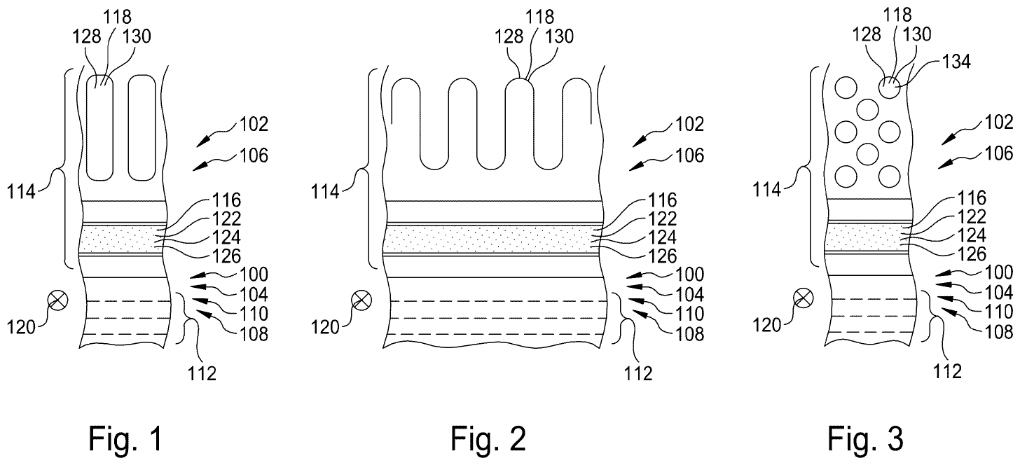

FIGS. 1 to 3 show fragments of different plates 100 in a schematic illustration. The plates 100 are plates for a plate stack arrangement 102. These are separator plates 104 for fuel cell stacks 106. The separator plates 104 can be, for example, metal plates 108 which can function as bipolar plates 110 in the respective fuel cell stack 106.

A flux field 112 is formed on or from the respective plate 100.

The plates 100, shown in FIGS. 1 to 3, define in each case individually, or conjointly with a plate 100 adjacent in the stack direction, a seal arrangement 114. The seal arrangement 114 serves to seal a space which is able to be established, or lies, in the plate stack arrangement 102.

These seal arrangements 114 comprise in each case a seal element 116 and a compression protection unit 118.

The seal element 116 can delimit the space which is able to be established, or can lie, in the plate stack arrangement 102 in at least one direction.

The compression protection unit 118 serves to protect the seal element 116 in relation to irreversible deformation during compression of the plate stack arrangement 102 along a plate stack longitudinal axis 120, the latter only being indicated by a cross, as it extends in the viewing direction of the observer in FIGS. 1, 2 and 3.

The seal element 116 of the plates 100 shown in FIGS. 1 to 3 has in each case a seal corrugation 122. The seal corrugation 122 is a full corrugation 124. The seal corrugation 122 is a perimeter corrugation 126. The seal corrugation 122 can enclose an electrochemical cell which can be disposed in the space.

In the plates 100 shown in FIGS. 1 to 3, the compression protection unit 118 has in each case one corrugation element 128. The corrugation element 128 forms in each case at least one first compression protection element 130.

The shape of the compression protection units 118 varies between the plates 100 shown in each case in FIG. 1, FIG. 2 and FIG. 3.

The compression protection units 118 shown in FIG. 1 are elongate and extend from the seal element 116 away toward a periphery of the plate 100.

The compression protection unit 118 shown in FIG. 2 meanders so as to reciprocate between a periphery of the plate 100 and the seal element 116.

The compression protection units 118 shown in FIG. 3 are round. These are studs 134 which are disposed between the periphery of the plate 100 and the seal element 116 and may be embossed in the plate, for example.

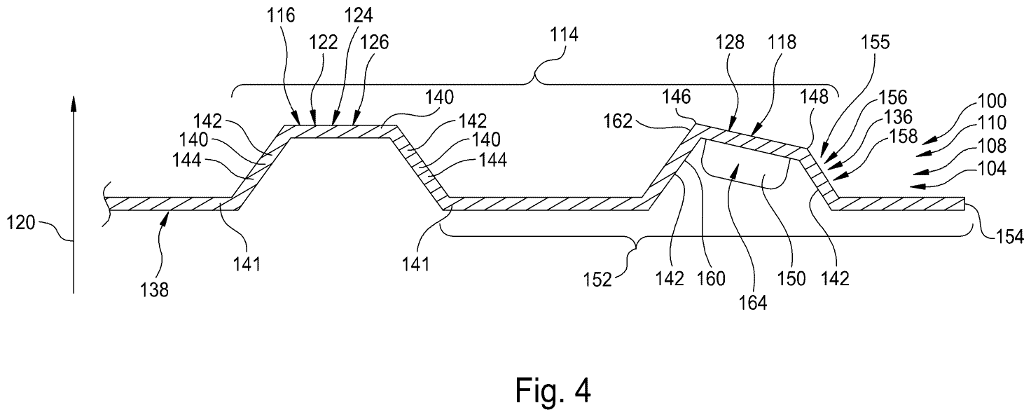

FIG. 4 shows a section through a peripheral region of a further plate 100. The plate 100 has two interconnected plate elements 136. The plate elements 136 are separator plate elements 155. These are metal plate elements 156 which function as bipolar plate elements 158. A main surface 138 of the one plate element 136 faces a main surface 138 of the other plate element 136. Only one of the plate elements 136 of the plate 100 is shown in FIG. 4.

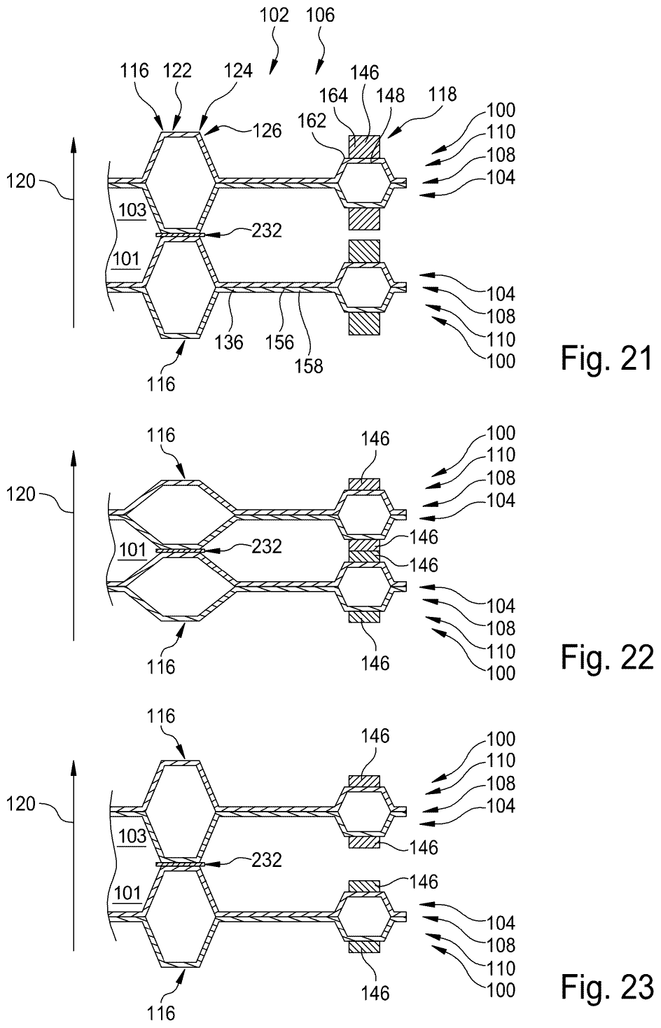

The plate 100 can solely, or conjointly with a plate 100 adjacent in the stack direction, form a seal arrangement 114. The seal arrangement 114 can serve to seal a space that lies in a plate stack arrangement 102, or is able to be established therein. This is illustrated in particular in FIGS. 21 to 26, however using different plates 100.

The seal arrangement 114 comprises a seal element 116 and a compression protection unit 118. The seal element 116 can delimit the space in at least one direction. The compression protection unit 118 can serve to protect the seal element 116 in relation to irreversible deformation during compression of a plate stack arrangement along a plate stack longitudinal axis 120. The plate stack longitudinal axis 120 extends orthogonally to the plate plane of the plate 100.

The seal element 116 has a seal corrugation 122. The seal corrugation 122 is a full corrugation 124. The latter can form a perimeter corrugation 126 of the plate 100, for example.

The seal corrugation 122 is formed from the plate 100.

The seal corrugation 122 comprises walls 140. A raised wall 140 is, by way of two further walls 140, linked to regions 141 of the plate 100 that are contiguous to the seal corrugation 122. These two walls 140 can be considered to be flanks 142 or legs 144 of the seal corrugation 122.

The compression protection unit 118 has a corrugation element 128. The compression protection unit 118 moreover has a first compression protection element 146 and a second compression protection element 148. The compression protection unit 118 moreover has a third compression protection element 150.

The corrugation element 128 is formed from the plate 100.

The compression protection unit 118 is formed in a peripheral zone 152. The peripheral zone 152 extends from the seal element 116 to a periphery 154 that delimits the surface extent of the plate 100.

The first compression protection element 146 and the second compression protection element 148 are disposed in such a way that during compression of a plate arrangement 102, which is able to be constructed from plates 100, along the plate stack longitudinal axis 120, compression of the first compression protection element 146 sets in before compression of the second compression protection element 148 sets in. For this purpose, the corrugation element 128 has two flanks 142 of different heights. The higher flank 142 extends up to the first compression protection element 146. The lower flank 142 extends up to the second compression protection element 148.

Since the first compression protection element 146 is raised more than the second compression protection element 148, during compression of the plate stack arrangement along the plate stack longitudinal axis 120, the compression of the first compression protection element sets in before the compression of the second compression protection element 148 sets in, the latter being raised to a lesser degree.

The corrugation element 128 has an inner surface 160 and an outer surface 162.

As explained above, the corrugation element 128 forms at least one of a plurality of compression protection elements 146 and 148. An absorption material 164, which is disposed on the inner surface 160 of the corrugation element 128, forms a third compression protection element 150 and thus a further one of a plurality of compression protection elements 146, 148 and 150.

The absorption material 164, or a further absorption material 164, could be disposed on the outer surface 162 and on the latter form a further one of a plurality of compression protection elements 146, 148 and 150. This is not illustrated in FIG. 4.

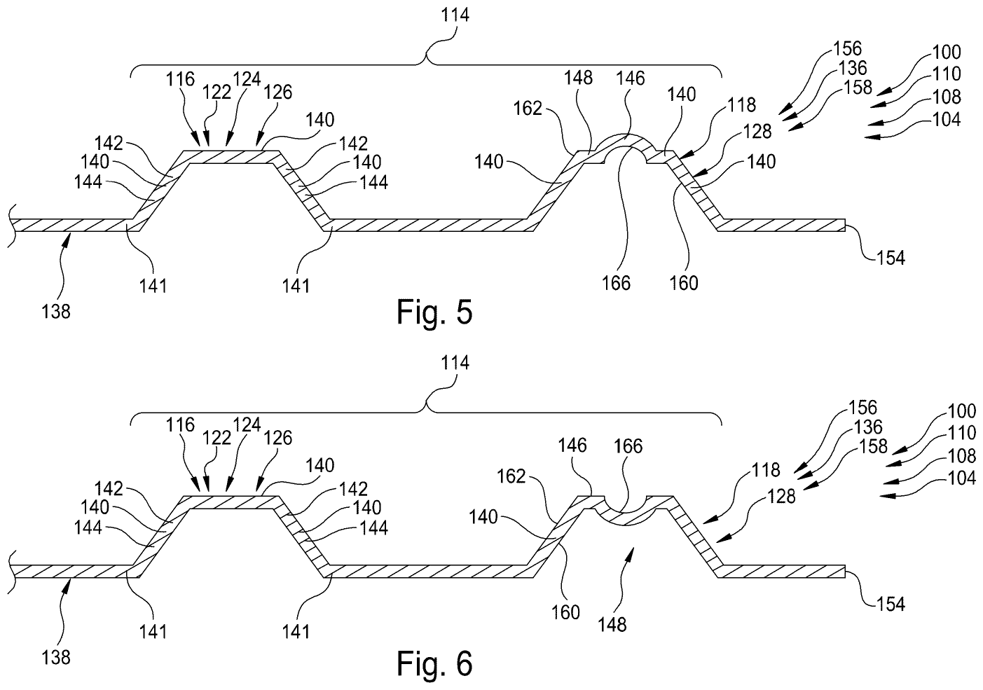

FIGS. 5 and 6 show further potential design embodiments for the compression protection unit 118

The compression protection units 118 shown therein also have in each case a corrugation element 128. FIGS. 5 and 6 show that a depression 166 is in each case formed in a wall 140 of the respective corrugation element 128. The depression 166 can be formed in the same direction as (FIG. 5) or in the direction counter to (FIG. 6) the corrugation element 128.

The depression 166 formed in the same direction can be a depression 166 which is incorporated into the inner surface 160. The depression 166 formed in the opposite direction can be a depression 166 which is incorporated into the outer surface 162.

The compression protection units 118 shown in FIGS. 5 and 6 also have in each case one first compression protection element 146 and one second compression protection element 148.

When the depression is formed in the same direction as the corrugation element 128, the first compression protection element 146 can be present on a base of the depression 166. The compression protection unit 118 shown in FIG. 5 is raised to the strongest degree in the region of the depression 166. Regions of the compression protection unit 118 which are raised to a lesser degree and are contiguous to the first compression protection element 146 can form a second compression protection element 148.

When the depression 166 is formed in the direction counter to the corrugation element 128, regions of the compression protection unit 118 that are contiguous to the depression 166 can form a first compression protection element 146. A base structure of the corrugation element 128, which lies below the depression 166, can form the second compression protection element 148.

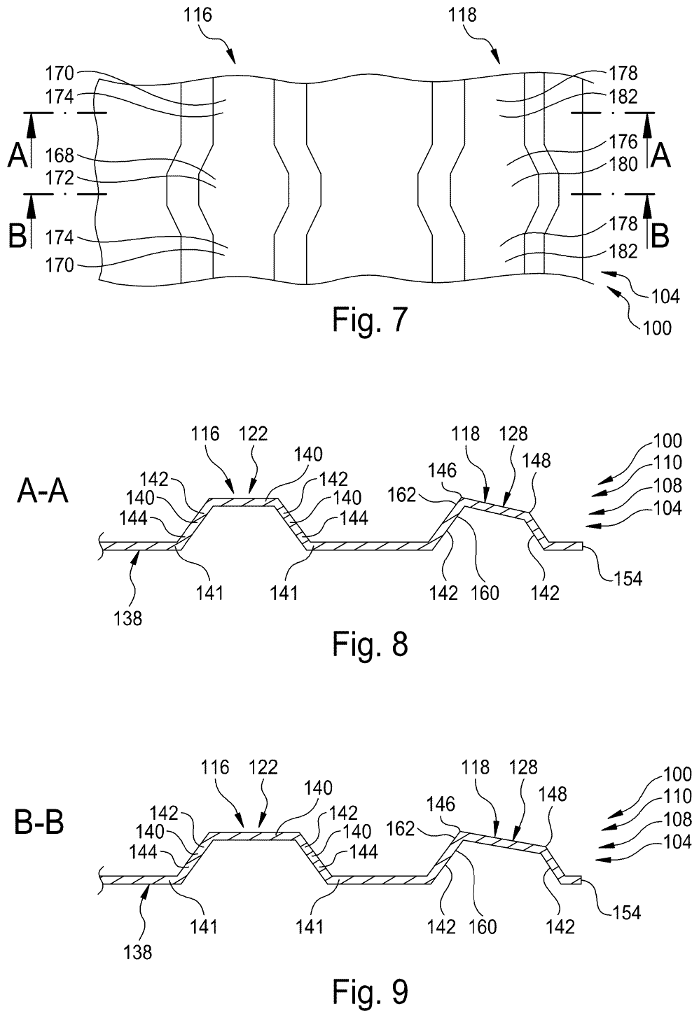

FIG. 7 shows a fragment of a plate 100, for example of a separator plate 104. FIG. 7 also shows a seal element 116 and a compression protection unit 118. The seal element has wider seal element portions 168 and narrower seal element portions 170. The seal element 116 has a seal corrugation 122. The wider seal element portions 168 are wider seal corrugation portions 172. The narrower seal element portions 170 are narrower seal corrugation portions 174.

The compression protection unit has wider compression protection unit portions 176 and narrower compression protection unit portions 178. The compression protection unit 118 has a corrugation element 128. The wider compression protection unit portions 176 are wider corrugation element portions 180. The narrower compression protection unit portions 178 are narrower corrugation element portions 182.

FIG. 8 shows a section through the plate 100 shown in FIG. 7. The section goes through a narrower seal element portion 170 and a narrower compression protection unit portion 178.

FIG. 9 shows a further section through the plate 100 shown in FIG. 7. The section goes through a wider seal element portion 168 and a wider compression protection unit portion 176.

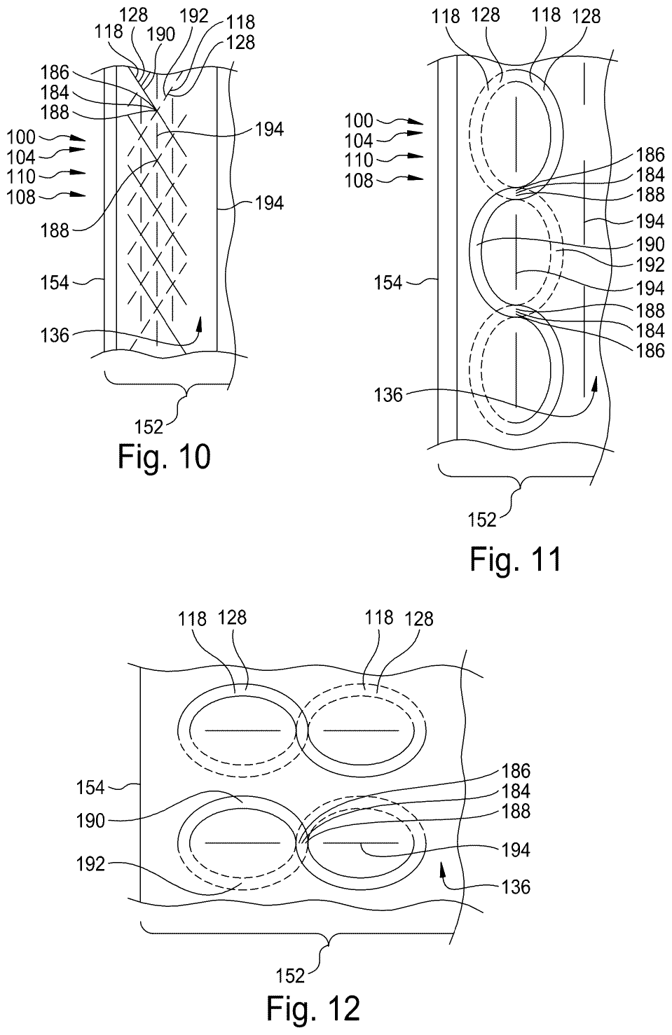

FIGS. 10 to 12 show in each case fragments of plates 100 in a schematic illustration. These are separator plates 104 in the form of metal plates 108 which can function as bipolar plates 110 in fuel cell stacks 106.

The plates 100 shown in FIGS. 10 to 12 have two plate elements 136 which are connected directly to one another.

One main surface of the one plate element 136 faces in each case a main surface of the other plate element 136. A respective plate element 136 which faces away from the observer is completely obscured by the plate element 136 which faces the observer, which is why certain features of the obscured plate element 136 are illustrated with dashed lines.

The fragments shown in FIGS. 10 to 12 show in each case only peripheral zones 152 of the respective plate 100. Compression protection units 118 which are formed in the respective peripheral zones 152 are likewise shown. The compression protection units 118 have in each case corrugation elements 128. Corrugation elements 128 which are formed from the respective plate element 136 that faces away from the observer are in each case illustrated with dashed lines in FIGS. 10 to 12.

The compression protection units 118 in FIGS. 10 to 12 are in each case disposed in such a way that a first compression protection unit portion 184 of the one compression protection unit 118 overlaps, e.g. in an overlap zone 188, a first compression protection unit portion 186 of the further compression protection unit of the plate element 136 which faces away from the observer. At least one second compression protection unit portion 190 of the one compression protection unit 118 overlaps a second compression protection unit portion 192 of the further compression protection unit 118 of the plate element 136 which faces away from the observer.

It is shown in FIGS. 10 and 11 that there can be a connection 194 of the plate elements 136 between two overlap zones 188 which are mutually offset in the plate plane, wherein compression protection unit portions 184 and 186 of different compression protection units 118, formed in each case from one of the two interconnected plate elements 136, overlap one another in the overlap zones 188.

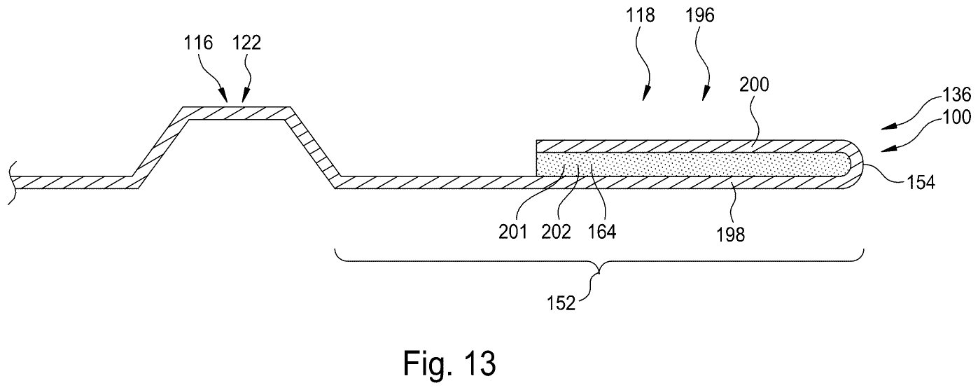

FIG. 13 shows a section through a plate 100. Only a fragment of the plate 100 is shown. Moreover, FIG. 13 shows only one of two plate elements 136 associated with the plate 100.

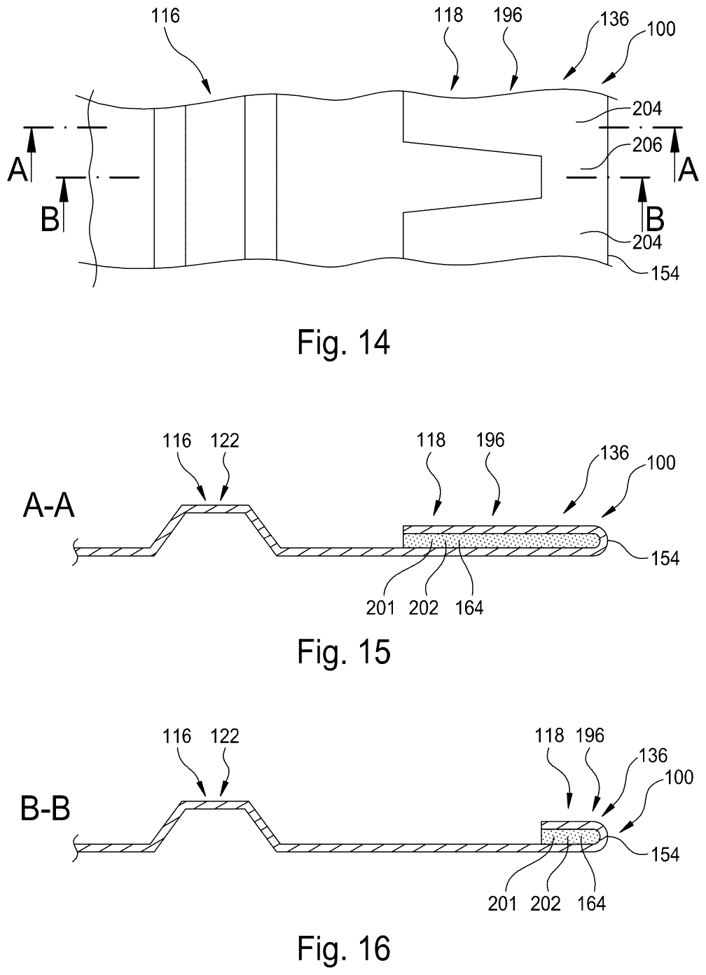

FIG. 14 shows a potential design embodiment in which the compression protection unit 118 has a multi-layer compression protection zone 196. The multi-layer compression protection zone 196 is formed in the peripheral zone 152.

A first layer 198 and a second layer 200 of the multi-layer compression protection zone 196 are formed by the same plate 100. Both layers extend so as to proceed from the periphery 154 delimiting the surface extent of the plate. The seal corrugation 122 is formed from the first layer 198 of the two layers 198 and 200. The second layer 200 of the two layers 198 and 200 extends from the periphery 154 in the direction toward the seal corrugation. A material 201 is disposed between the two layers 198 and 200. The material 201 can be a filler material 202 or an absorption material 164, or contain such materials.

FIG. 14 shows a view from above onto a plate 100 having a multi-layer compression protection zone 196. One portion 204 of the multi-layer compression protection zone 196 is wider than another portion 206 of the multi-layer compression protection zone 196. In the wider portion 204 of the multi-layer compression protection zone 196, the second layer 200 extends farther from the periphery 154 in the direction toward the seal element 116 than in the other portion 206 of the multi-layer compression protection zone 196.

FIGS. 15 and 16 show sections of the plate 100 shown in FIG. 14, wherein only one of the two plate elements 136 of the plate is in each case shown. FIG. 15 shows a section through a wider portion 204. FIG. 16 shows a section through a narrower portion 206.

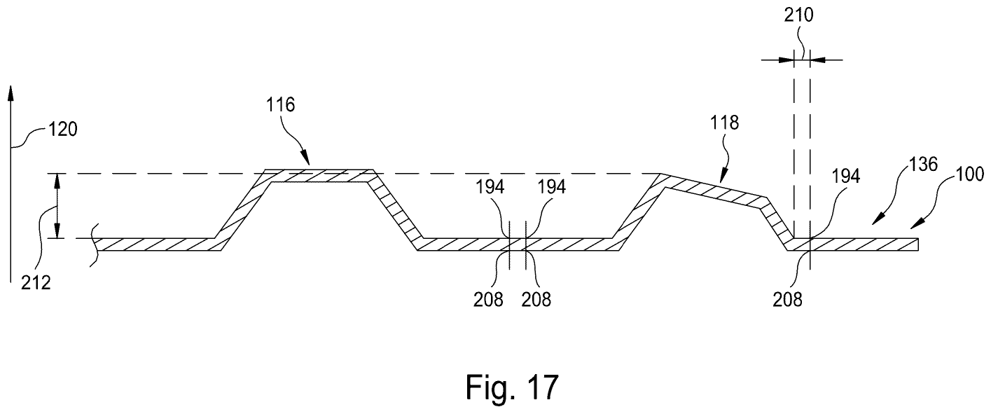

In the portion of a plate 100 shown in FIG. 17, the seal element 116 and the compression protection unit 118 are embodied almost as shown in FIG. 4.

Only one of two plate elements 136 of the plate 100 is also illustrated in FIG. 17.

Additionally, possibilities for establishing a connection 194 are shown in dashed lines in FIG. 17, wherein the connection 194 can be a connection to the further plate element 136, not illustrated in FIG. 17.

The connection 194 to the further plate element 136, not illustrated, can in each case be established by way of a welding zone 208. The two plate elements 136 can be welded to one another in the welding zone 208.

Also plotted in FIG. 17 is a spacing 210 of the compression protection unit 118 from a nearest location where there can be a connection 194 of the plate elements 136. Moreover, the greatest extent 212 of the compression protection unit 118 in the direction of the plate stack longitudinal axis 120 is plotted in FIG. 17.

The spacing 210 is approximately 50% of the greatest extent 212.

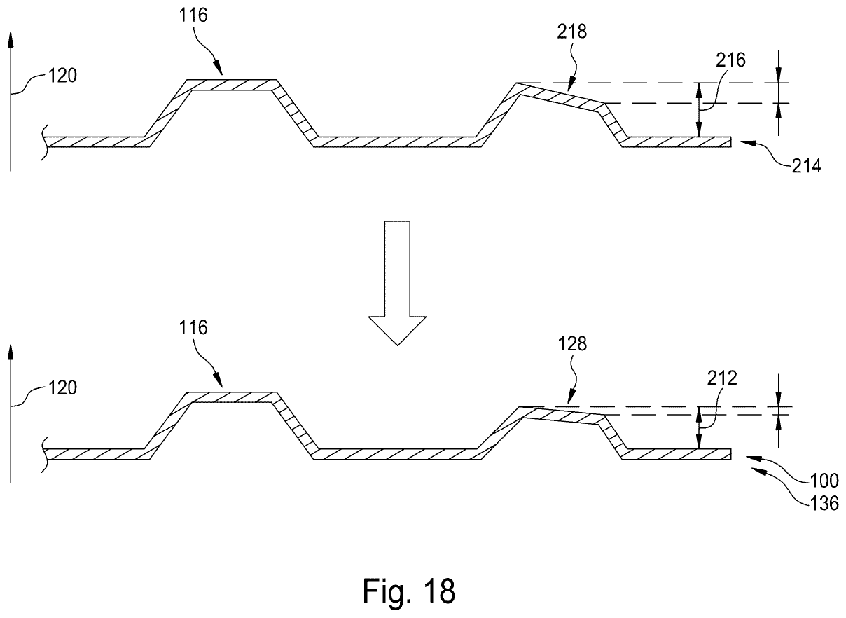

FIG. 18 illustrates how a plate intermediate product 214 can be transformed, in particular by forming, into a plate 100, or into a plate element 136.

The plate intermediate product 214 has a corrugation precursor element 218. The shape and/or the cross section of the corrugation precursor element 218 establishes a maximum precursor extent 216 of the corrugation precursor element 218 in the direction of a later plate stack longitudinal axis 120.

The corrugation precursor element 218 can be transformed, or formed, in such a way that the maximum precursor extent 216 is modified toward the desired greatest extent 212 of the corrugation element 128 being created.

For this purpose, the corrugation precursor element 218 can be entirely or partially leveled and, as a result, transformed into the corrugation element 128.

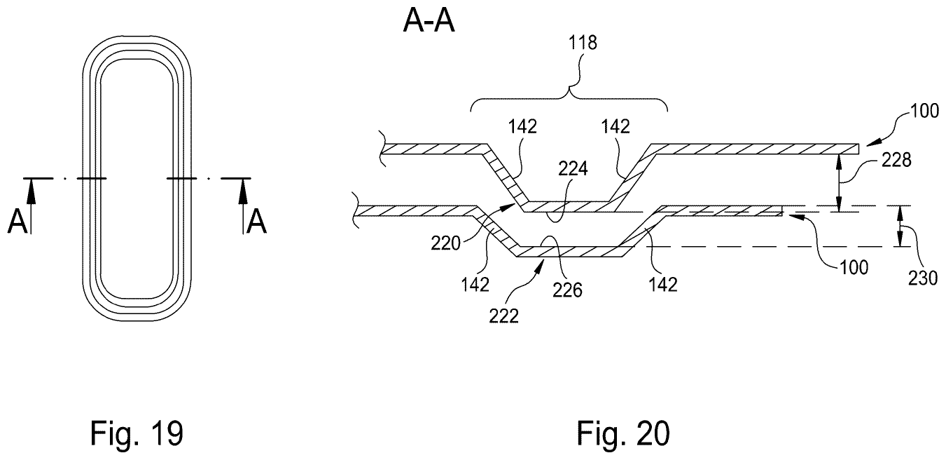

FIGS. 19 and 20 illustrate a potential design embodiment, wherein the compression protection unit 118 has an elevation element 220 and a depression element 222, wherein part of an elevation 224 of the elevation element 220 is received in a depression 226 of the depression element 222.

FIG. 19 illustrates that the elevation element 220 and the depression element 222 can in each case be a corrugation element 128. An elevation height 228 of the elevation 224 is larger than a depression depth 230 of the depression 226.

In the depression 226, flanks 142 of the elevation are spaced apart from flanks 142 of the depression 226. The spacing of the flanks is such that the flanks 142 of the elevation 224 can spread toward the flanks 142 of the depression 226. Owing to this fact, a compression protection function can be generated for a seal element which is disposed between the plates 100 so as to be spaced apart from the compression protection unit 118.

FIGS. 21 to 23 illustrate the behavior of a plate stack arrangement 102, and in particular of a fuel cell stack 106, during compression of the plate stack arrangement 102 along a plate stack longitudinal axis 120. Shown in each case are only two plates 100 of the plate stack arrangement 102, thus only part of the fuel cell stack 106. The plates 100 have in each case two interconnected plate elements 136.

The seal arrangement shown in FIGS. 21 to 23 comprises in each case one seal element 116 and one compression protection unit 118. The seal element 116 surrounds the space 101. The space 101 is the plate intermediate space 103.

The seal elements 116 shown have seal corrugations 122. The respective seal corrugation 122 is a full corrugation 124. Said seal corrugations can form a perimeter corrugation 126 of the respective plate 100, for example. The seal corrugations 122 are in each case formed from a plate 100, or in each case from a plate element 136 of the respective plate 100, respectively. An insulation 232 is disposed between mutually facing seal corrugations 116.

The respective compression protection units 188 have corrugation elements 128. Moreover, the respective compression protection unit 118 has a first compression protection element 146 and a second compression protection element 148.

The first compression protection element 146 and the second compression protection element 148 are in each case disposed and embodied in such a way that during compression along the plate stack longitudinal axis 120, illustrated in FIG. 22, compression of the first compression protection element 146 sets in before compression of the second compression protection element 148 can set in.

The relatively soft absorption material 164, which is disposed on the outer surface 162 of the corrugation element 128, forms in each case the first compression protection element 146. It is thus raised more than the second compression protection element 148. During compression of the plate stack arrangement 102 along the plate stack longitudinal axis 120, the compression of the first compression protection element 146 sets in before the compression of the second compression protection element 148, raised to a lesser degree, sets in.

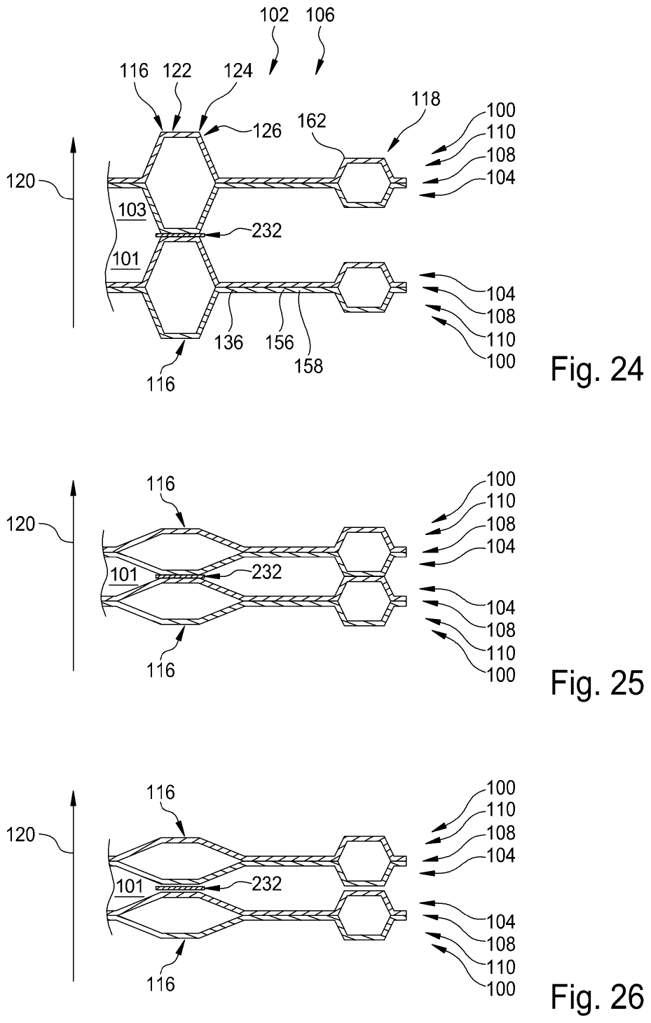

The compression protection unit 118 can serve to protect the seal element 116 in relation to irreversible deformation during compression of a plate stack arrangement along a plate stack longitudinal axis 120. This is particularly evident from FIGS. 24 to 26 which show the behavior of a further plate stack arrangement 102 during compression along the plate stack longitudinal axis 120. The plate stack arrangement 102 shown in FIGS. 24 to 26 corresponds to that from FIGS. 21 to 23, but the first compression protection element is in each case absent. Here, the compression along the plate stack longitudinal axis has such a heavy impact on the seal elements 116 that the latter are irreversibly deformed.

Instead, in FIGS. 21 to 23, only the first compression protection element 146 is reversibly, or possibly irreversibly, deformed-after the same force acting along the plate stack longitudinal axis 120.

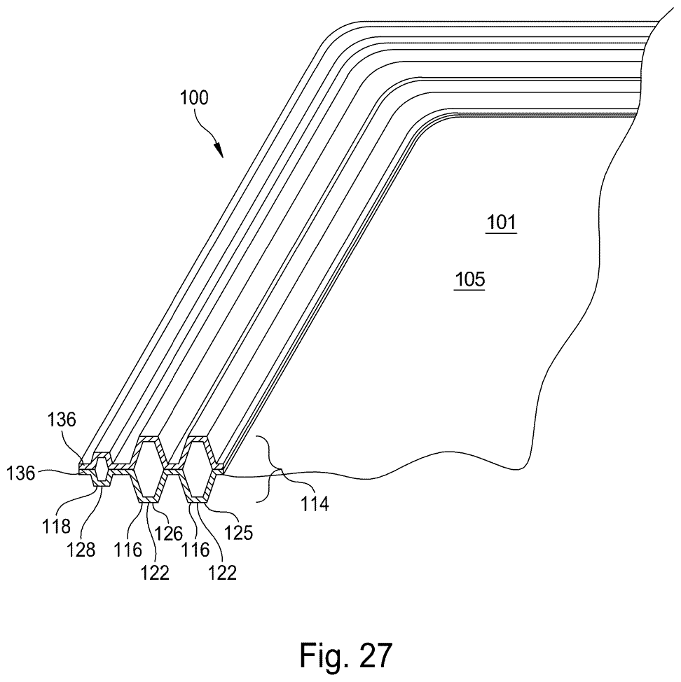

FIG. 27 shows a fragment of a plate 100 which is constructed from two connected plate elements 136. The plate is a separator plate 104 for a fuel cell stack not shown in more detail here. The seal arrangement 114 comprises a first seal element 116 and a second seal element 116. The two seal elements 116 surround different spaces 101.

The first seal element 116 surrounds a plate intermediate space not shown here. The second seal element 116 surrounds at least part of a conduit space 105 which extends through the plate 100 and of which only a fragment is shown in FIG. 27. Both seal elements 116 have in each case a seal corrugation 122.

The seal corrugation 122 of the first seal element 116 is a perimeter corrugation 126. The perimeter corrugation 126 delimits the plate intermediate space in relation to an environment of the plate stack arrangement.

The seal corrugation of the second seal element 116 is a port corrugation 125 which surrounds at least part of the conduit space 105.

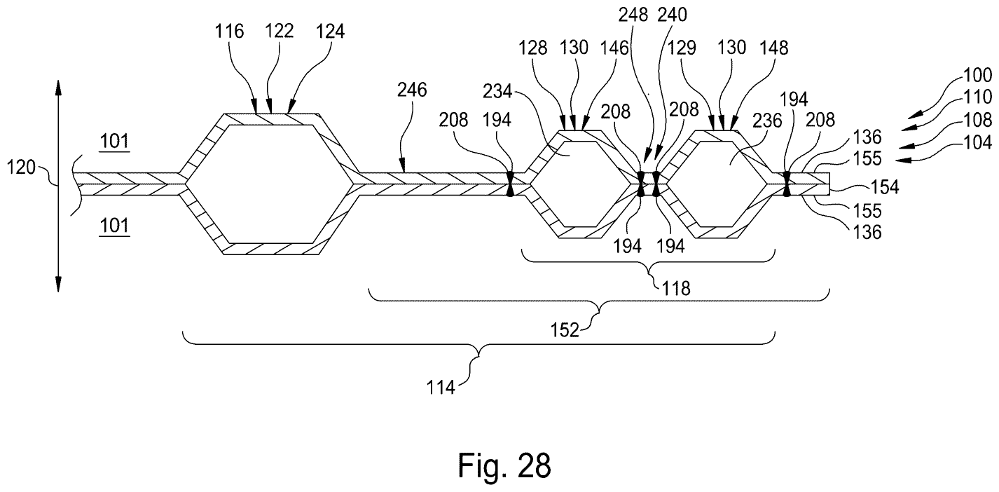

FIG. 28 shows a section through a peripheral region of a further plate 100. The plate 100 has two interconnected plate elements 136. The plate elements 136 are separator plate elements 155. These are metal plate elements which function as bipolar plate elements.

The plate 100 can solely, or conjointly with a plate 100 adjacent in the stack direction, form a seal arrangement 114. The seal arrangement 114 can serve to seal a space 101 lying or establishable in a plate stack arrangement 102. This is illustrated in particular in FIGS. 21 to 26, however using other plates 100.

The seal arrangement 114 comprises a seal element 116 and a compression protection unit 118. The seal element 116 can delimit the respective space 101 in respectively at least one direction. The compression protection unit 118 can serve to protect the sealing element 116 from irreversible deformation during compression of a plate stack arrangement along a plate stack longitudinal axis 120. The plate stack longitudinal axis 120 extends orthogonally to the plate plane of the plate 100.

The seal element 116 has a seal corrugation 122. The seal corrugation is a full corrugation 124. The latter can form a perimeter corrugation of the plate 100, for example.

The seal corrugation 122 is formed from the plate 100.

In the seal arrangement shown in FIG. 28, the compression protection unit 118 defines a first elevation zone 234 and a second elevation zone 236.

The compression protection unit 118 is raised in the first elevation zone 234 and in the second elevation zone 236 in the direction of the plate stack longitudinal axis 120 in comparison to a base portion 246 of the seal arrangement 114, wherein the base portion 246 lies between the seal element 116 and the compression protection unit 118.

The compression protection unit 118 has a corrugation element 128 and a further corrugation element 129. The corrugation element 128 defines the elevation zone 234. The further corrugation element 129 defines the second elevation zone 236.

It would likewise be conceivable that the compression protection unit has only the corrugation element 128, but not the corrugation element 129, and the corrugation element 128 defines the two elevation zones 234 and 236. For this purpose, the corrugation element 128 could be disposed or formed completely in a peripheral zone portion 270 of the peripheral zone 152, for example. The corrugation element 128 can be formed in the peripheral zone portion 270 to be encircling in an annular manner, as is illustrated in FIG. 31 for example.

The compression protection unit 118 has an intermediate portion 248 between the first elevation zone 234 and the second elevation zone 236.

The compression protection unit 118 is not raised in the intermediate portion 248 in the direction of the plate stack longitudinal axis 120 in comparison to the base portion 246.

FIG. 28 shows that there is a connection 194 of the plate elements 136 in the peripheral zone 152 of the seal arrangement 114. There is a connection 194 between the seal element 116 and the compression protection unit 118. There is a connection 194 between the compression protection unit 118 and the periphery 154. There is a connection between the different elevation zones 234 and 236 within the compression protection unit 118.

The connections 194 have welding zones 208. The plate elements 136 are welded to one another in the welding zones 208.

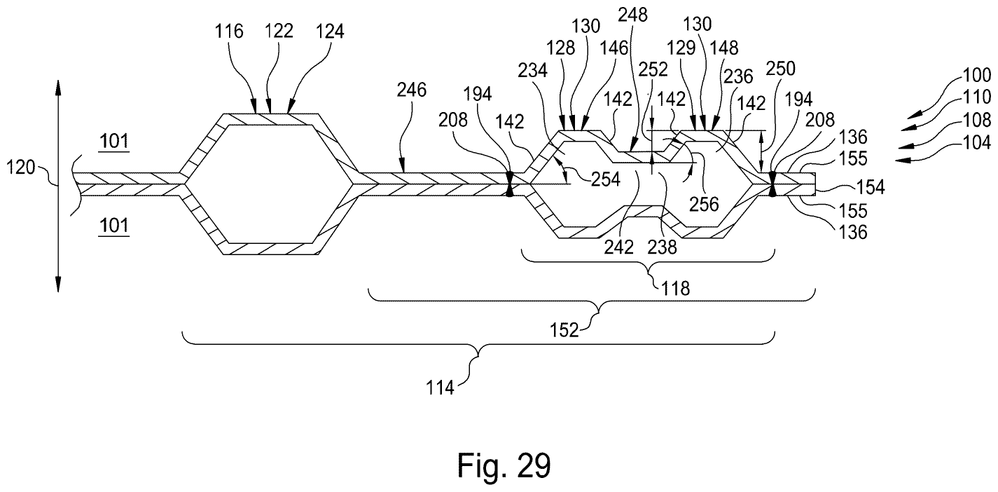

FIG. 29 shows a section through a peripheral region of a further plate 100. This plate 100 is similar to the plate shown in FIG. 28, which is why only the differences with respect to the plate 100 shown in FIG. 28 will be described hereunder:

In the seal arrangement 114 shown in FIG. 29, the compression protection unit 118 also has an intermediate portion 248 between the first elevation zone 234 and the second elevation zone 236. In the seal arrangement shown in FIG. 29, the intermediate portions 248 defines an intermediate elevation zone 242. In the intermediate elevation zone 242, the intermediate portion 248 is raised in the direction of the plate stack longitudinal axis 120 in comparison to the base portion 246, wherein the compression protection unit 118 is in each case raised in the first elevation zone 234 and in the second elevation zone 236 in the direction of the plate stack longitudinal axis more than the intermediate portion 248.

FIG. 29 shows that an intermediate height 252 of the compression protection unit 118, able to be measured so as to proceed from the intermediate portion 248 in the direction of the plate stack longitudinal axis, on the second elevation zone 236 is approximately 50% of a base height 250 of the compression protection unit, able to be measured so as to proceed from the base portion 246 in the direction of the plate stack longitudinal axis 120, on the same elevation zone 236.

FIG. 29 shows that the corrugation elements 128 and 129 have flanks 142 of different heights. The number of flanks is four. A higher flank 142, which extends proceeding from the base portion 246, is of a flatter inclination than a flank 142 which is of lesser height and extends proceeding from the intermediate portion 248.

The smaller inclination angle 254 of the higher flank 142 is plotted in FIG. 29, as is the larger inclination angle 256 of the flank 142 of lesser height.

The smaller inclination angle 254 is 50°, for example. The larger inclination angle 256 is 60°, for example.

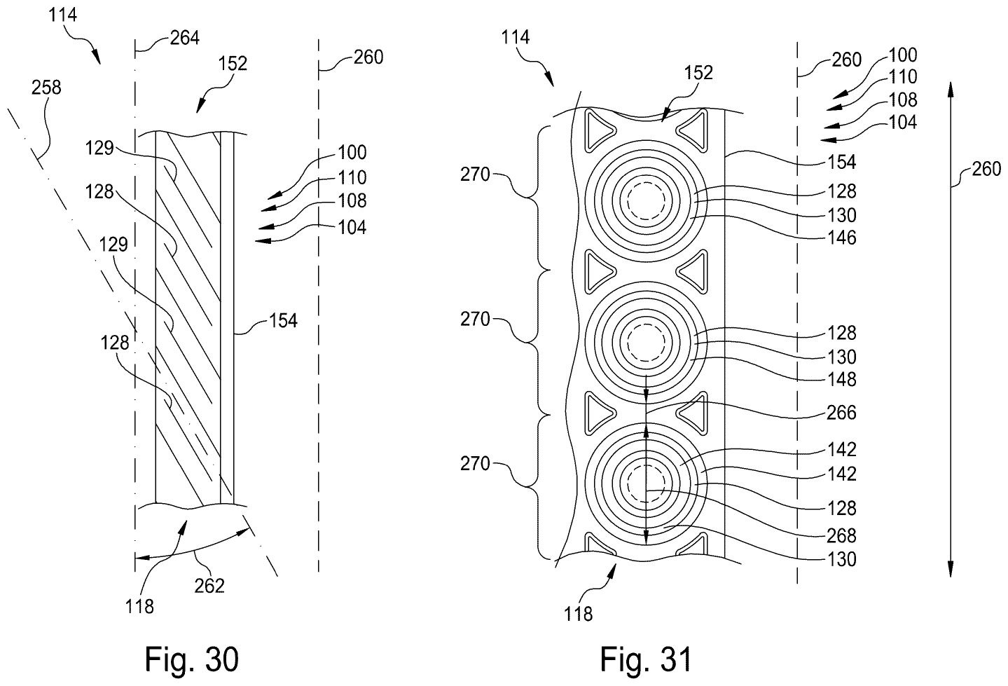

FIGS. 30 and 31 show fragments of different plates 100 in a schematic illustration. The plates 100 are plates for a plate stack arrangement 102. These are separator plates 104 for fuel cell stacks 106. The separator plates 104 can be, for example, metal plates 108 which can function as bipolar plates 110 in the respective fuel cell stack 106.

Shown in both FIGS. 30 and 31 is in each case only a small fragment which does not show the entire seal arrangement 114 but only the compression protection unit 118 comprised by the seal arrangement.

The compression protection unit has corrugation elements 128 and 129. The corrugation elements 128 and 129 extend in a compression protection unit direction of extent 258 along which at least one part of the compression protection unit 118 extends. The compression protection unit direction of extent 258 encloses an extent angle 262 of approximately 35° in relation to a seal element direction of extent 264 along which part of the seal element which is next adjacent to the at least one part of the compression protection unit 118 extends.

FIG. 30 shows that there is a connection of plate elements 136, not described in more detail in the figure, in the peripheral zone 152 of the seal arrangement 114, only shown partially there, between a seal element 116, not shown, and the compression protection unit 118 of the seal arrangement 114, between the compression protection unit 118 and the periphery 154 and within the compression protection unit between different corrugation elements 128 and 129.

Of the seal arrangement 114 shown in FIG. 31, only the compression protection unit 118 is also shown there. The compression protection unit 118 shown there has a first compression protection element 146 and a second compression protection element 148. The two compression protection elements 146 and 148 are formed in the peripheral zone 152.

The compression protection elements 146 and 148 are in each case formed completely in a peripheral zone portion 270 of the peripheral zone.

The peripheral zone portions 270 extend from the seal element 116, not shown, in the radial direction up to the periphery 154. A respective peripheral zone portion 270 extends along the peripheral direction of extent 260 only over a minor portion of e.g. 5% of the peripheral length, wherein the peripheral length is a length of the periphery 154.

The compression protection elements 146 and 148 are in each case formed so as to be encircling in an annular manner, e.g. circular, within the respective peripheral zone portion 270.

It is likewise conceivable in particular in the context of FIG. 31 that a second compression protection element 148 is in each case formed on the inside, wherein the respective second compression protection element 148 is in each case surrounded by a first compression protection element 146. For example, corrugation elements 128 can be formed in each case so as to be encircling in an annular manner in the peripheral zone portion 270, as is illustrated in FIG. 31. As opposed to what is provided by the reference signs in FIG. 31, said corrugation elements can form in each case a first compression protection element 146 and in each case surround a second compression protection element 148.

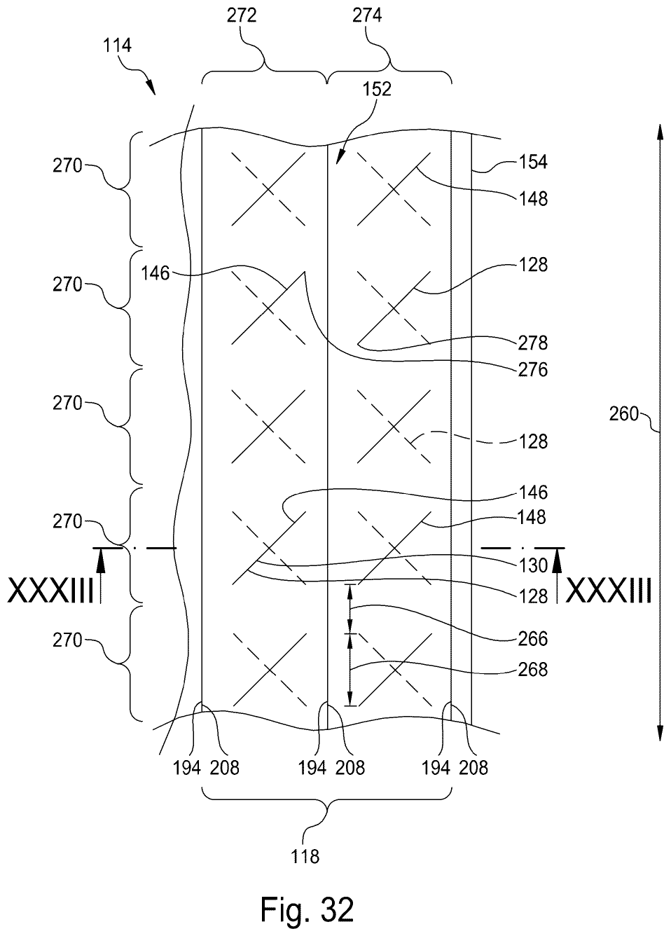

FIG. 32 likewise shows only a fragment of a seal arrangement 114, wherein the fragment shows the compression protection unit 118, but not the associated seal element 116. Two compression protection elements 130, 146, 148 are in each case formed in a plurality of peripheral zone portions 270 which are successive along the peripheral direction of extent 260.

A compression protection element extent 268, able to be measured in the direction of the peripheral direction of extent 260, of the compression protection elements 130, 146, 148 is in each case greater than a compression protection element spacing 266, able to be measured in the direction of the peripheral direction of extent 260, of two adjacent compression protection elements 130, 146, 148 which are disposed or formed in successive peripheral zone portions 270. FIG. 31 also shows such a ratio of compression protection element extent 268 to compression protection element spacing 266.

FIG. 32 shows that a first of the two compression protection elements 130, 146, 148 in the peripheral zone 152 lies farther away from the periphery 154 than a second of the compression protection elements 130, 146, 148.

An outer end 276 of the compression protection element 146 lying farther away from the periphery 154 in the peripheral zone 152 lies farther away from the periphery 154 than an inner end 278 of the second compression protection element 148.

In a plurality of peripheral zone portions 270 which are successive along the peripheral direction of extent 260, one compression protection element 130, 146, 148 is in each case formed on the inside in the peripheral zone 152, and another compression protection element 130, 146, 148 is in each case formed on the outside in the peripheral zone 152.

The peripheral zone 152 comprises an outer peripheral zone 274 which is closer to the periphery 154 and an inner peripheral zone 272 which is farther away from the periphery 154. A plurality of compression protection elements 130, 146, 148 which are adjacent in the direction of the peripheral direction of extent 260 are formed in the outer peripheral zone 274. A plurality of compression protection elements 130, 146, 148 which are adjacent in the direction of the peripheral direction of extent 260 are formed in the inner peripheral zone 272. Since FIG. 32 shows the compression protection elements 130, 146, 148 only in a highly simplified manner as lines, it cannot be seen from the figure that the compression protection elements 130, 146, 148 may be corrugation elements 128.

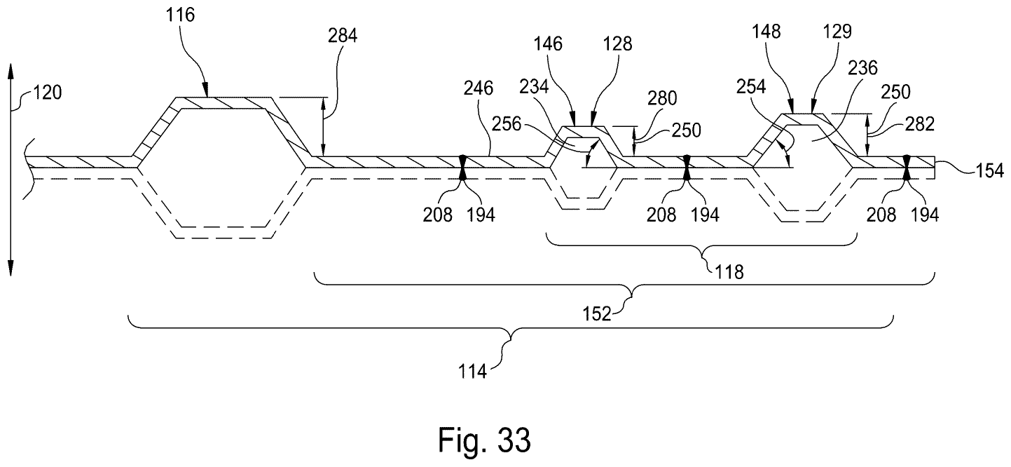

The seal arrangement 114 shown in FIG. 33 is similar to the seal arrangement shown in FIG. 28. Deviating from the seal arrangement shown in FIG. 28, in the seal arrangement shown in FIG. 33, the compression protection unit 118 is raised in the first elevation zone 234 in the direction of the plate stack longitudinal axis 120 in comparison to the base portion 246 of the seal arrangement 114 to a lesser degree than in the second elevation zone 236. The base portion 246 lies between the seal element 116 and the compression protection unit 118. The first elevation zone 234 is an elevation zone of the first compression protection element 146. The second elevation zone 236 is an elevation zone of the second compression protection element 148.

The first compression protection element 146 lies in the peripheral zone 152 farther away from the periphery 154 than the second compression protection element 148.

The first compression protection element 146 shown in FIG. 33 is a corrugation element 128. The second compression protection element 148 shown in FIG. 33 is a corrugation element 129. The second compression protection element 148 has a flank 142 of flatter inclination. The first compression protection element 146 has a flank 142 of steeper inclination. A smaller inclination angle 254 of the flank 142 of flatter inclination can be 45°, for example. A larger inclination angle 256 of the flank 142 of steeper inclination can be 60°, for example.

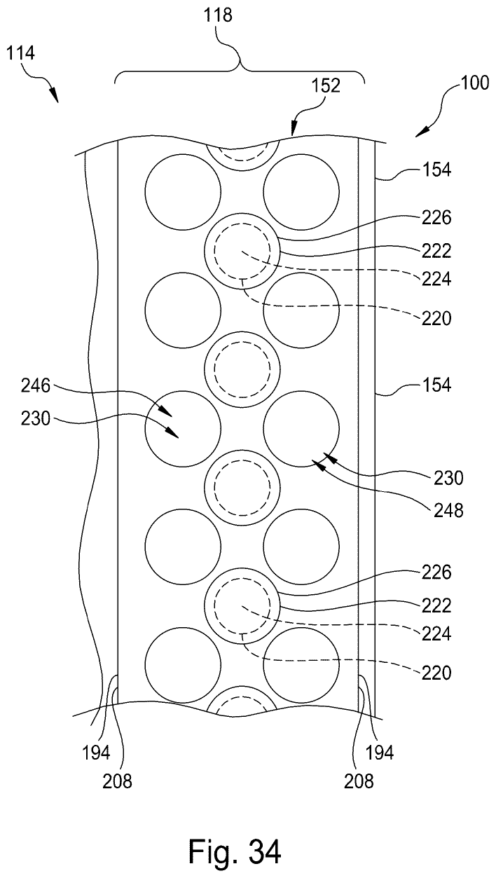

FIG. 34 likewise shows a fragment of a seal arrangement 114, wherein the compression protection unit 118 is illustrated, but not the seal element 116 lying outside the fragment.

Features of a plate element 136 which faces the observer are illustrated with solid lines in FIG. 34. Features of a plate element 136 of the same plate 100 that faces away from the observer are illustrated with dashed lines in FIG. 34.

The compression protection unit 118 shown in FIG. 34 has an elevation element 220 and a depression element 222. Part of an elevation of the elevation element 220 can be received in a depression of the depression element 222. Alternatively, part of an elevation of the elevation element 220 may be able to be received in a depression of the depression element 222 when a deformation of the compression protection unit 118 occurs during compression of the plate stack arrangement 102 along a plate stack longitudinal axis 120.

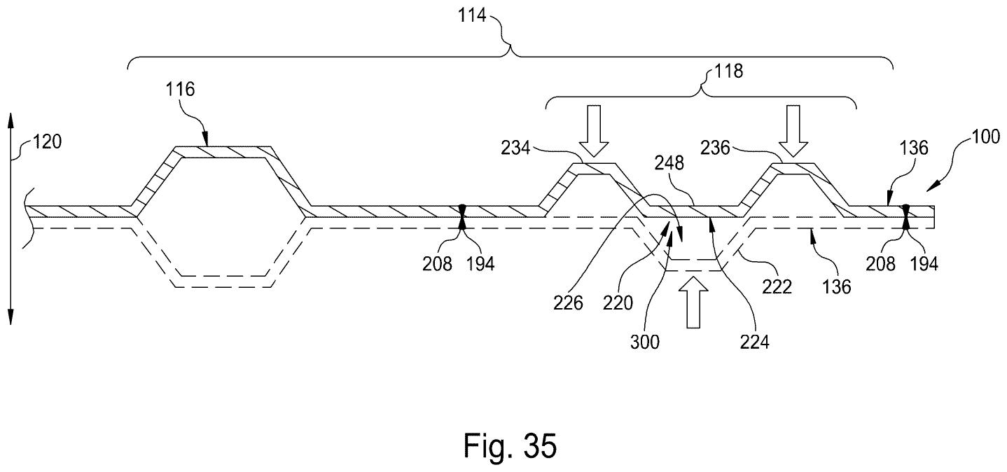

Such a deformation will be illustrated by means of the section through a peripheral region of a further plate 100 that is shown in FIG. 35. In FIG. 35, the black arrows represent a compression of a plate stack arrangement, which can be constructed from several plates 100 according to FIG. 35, for example, along the plate stack longitudinal axis 120. The white arrows, illustrated with a black contour, indicate the deformation of the compression protection unit 118. Part of the elevation 224 of the elevation element 220 of a plate element 136 illustrated at the top in FIG. 35 is able to be received in the depression 226 of the depression element 222 of a plate element 136 illustrated at the bottom in FIG. 35, when the deformation of the compression protection unit 118 occurs during the compression along the plate stack longitudinal axis 120.

The compression protection unit 118 has an intermediate portion 248 between the first elevation zone 234 and the second elevation zone 236. The intermediate portion 248 forms the elevation 224. The elevation element 220 is formed by a counter-elevation zone 300 in which the compression protection unit between the first elevation zone 234 and the second elevation zone 236 is raised counter to the direction of the elevation zones 234 and 236.

FIG. 34 shows that the compression protection unit 118 has a plurality of elevation elements 220 and of depression elements 222. Only part of the depression elements 222 and of the elevation elements 220 are provided with reference signs.

Part of an elevation 224 of each elevation element 220 is in each case received in a corresponding depression 226 of the depression element 222 or able to be received in a corresponding depression 226 of the depression element 222, when the deformation of the compression protection unit 118 occurs during compression of the plate stack arrangement 102 along a plate stack longitudinal axis 120.

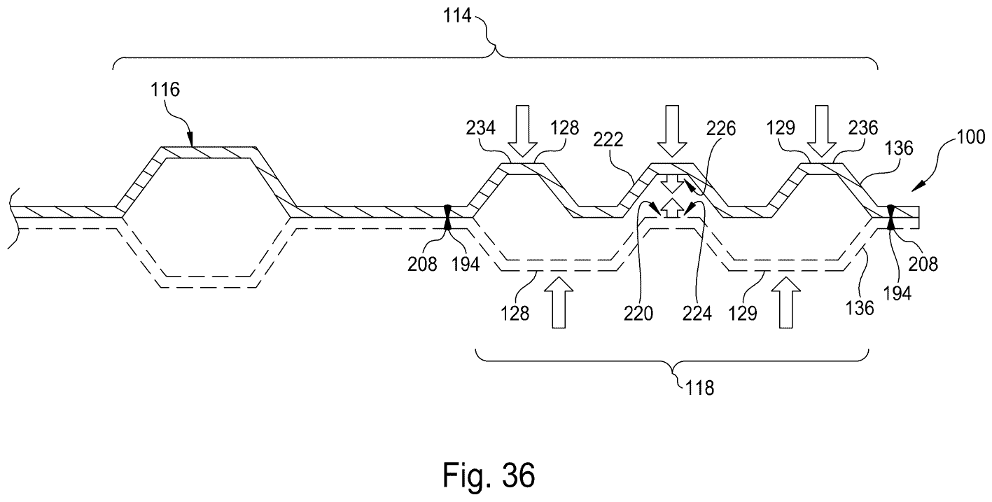

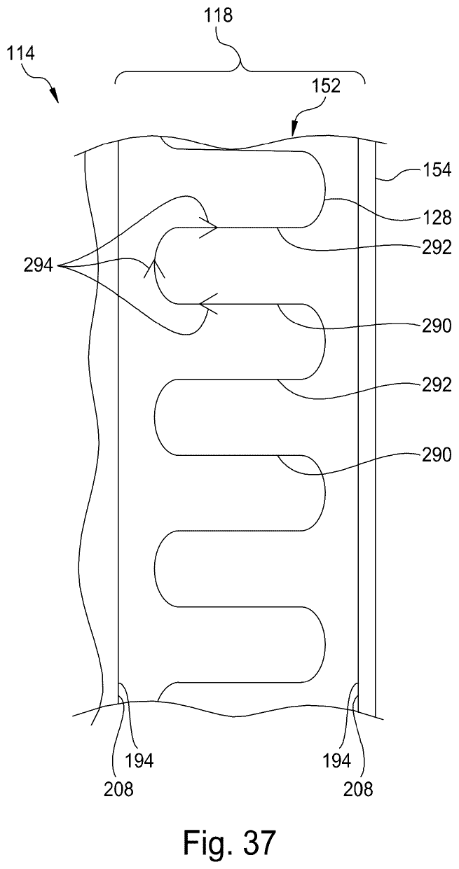

FIG. 36 shows a section through a peripheral region of a further plate 100. The seal arrangement 114 shown in FIG. 36 differs from the seal arrangement shown in FIG. 35 in particular in that the elevation element 220 and the depression element 222 are in each case formed between corrugation elements 128, 129.

It can be preferable when the elevation element 220 is an elevation element 220 formed from a first plate element 136 of a plate 100, and the depression element 222 is a depression element 222 formed from a second plate element 136 of a plate 100.

FIG. 37 shows a further compression protection unit 118 of a seal arrangement 114. The degree of bending of a corrugation element 128 of the compression protection unit 118 alternately increases and decreases along a direction of extent 294 of the compression protection unit 118. The corrugation element 128 of the compression protection unit 118 bends alternately in one direction and in the direction counter to the latter along a direction of extent 294 of the compression protection unit 118. The corrugation element 128 of the compression protection unit 118 extends in a rectilinear manner between the alternating bends. The corrugation element 128 of the compression protection unit 118 extends in a meandering manner in the peripheral zone 152.

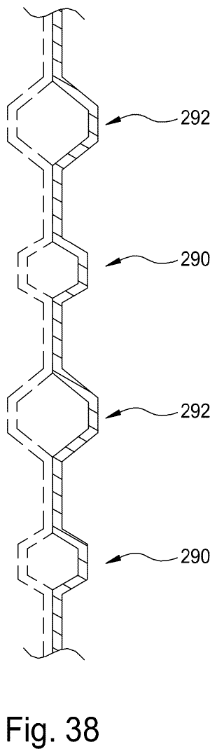

FIG. 38 shows section A-A from FIG. 37. FIG. 38 shows that the corrugation element 128 has lower compression protection unit portions 290 and higher compression protection unit portions 292. A low compression protection unit portion 290 can transition into a higher compression protection unit portion 292 in a bend.

A height of the compression protection unit 118 can be greater in the higher compression protection unit portion 292 than a height of the compression protection unit 118 in a lower compression protection unit portion 290.

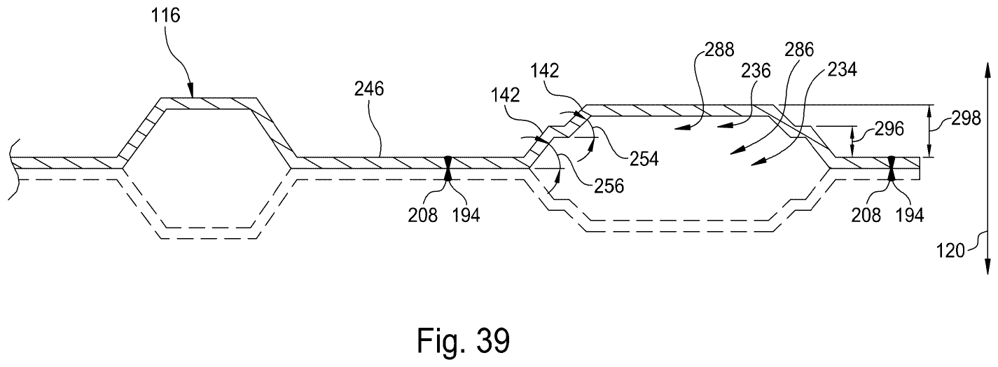

FIG. 39 shows section B-B from FIG. 37. FIG. 39 shows a first elevation zone 234 and a second elevation zone 236. The first elevation zone 234 is a body elevation zone 286. The second elevation zone 236 is a head elevation zone 288 which adjoins the body elevation zone in the direction of the plate stack longitudinal axis 120. A flank 142 of the head elevation zone 288 is of a flatter inclination than a flank 142 of the body elevation zone 286. A smaller inclination angle 254 of a flank 142, of flatter inclination, of the head elevation zone 288 can be approximately 30°, for example. A larger inclination angle 256 of a flank 142, of steeper inclination, of the body elevation zone 286 can be approximately 50°, for example.

The compression protection unit has a head elevation zone 288 only in the higher compression protection unit portion 292. The overall height 298 is the sum of the heights of the body elevation zone 286 and of the head elevation zone 288. The body height 296 is the height of the body elevation zone 286. The ratio of the body height 296 to the overall height 298 can be 0.7, for example.

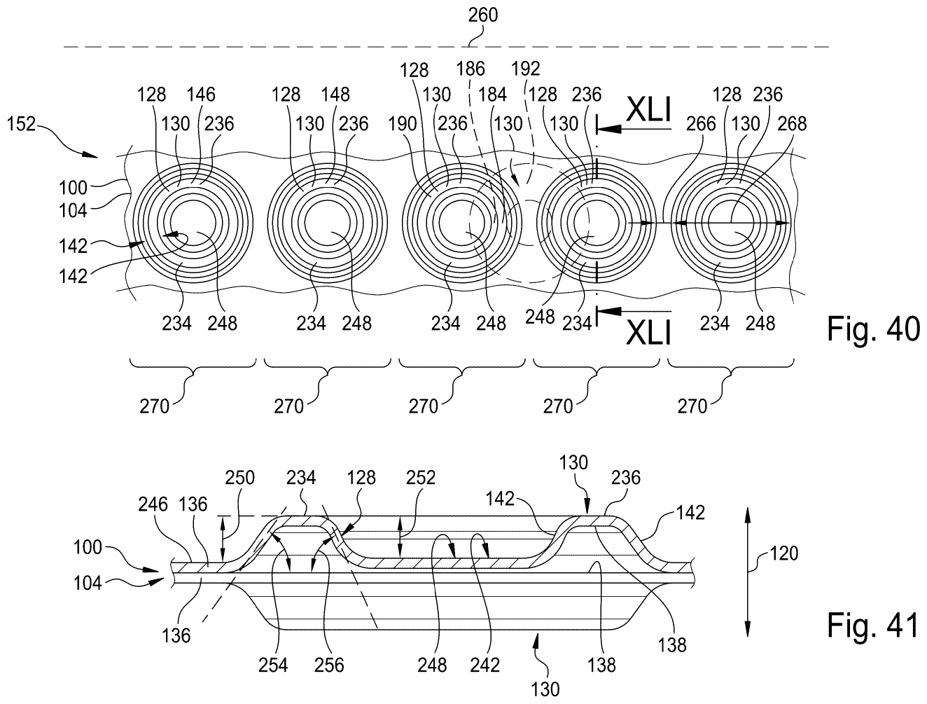

A small fragment of a seal arrangement 114 is shown in FIG. 40. The seal arrangement 114 comprises a compression protection unit 118 for protecting a seal element 116, not illustrated in the small fragment, of the seal arrangement 114 from irreversible deformation during compression of a plate stack arrangement along a plate stack longitudinal axis.

The compression protection unit 118 has many compression protection elements 130, of which a compression protection element 130 in FIG. 40 is arbitrarily referred to as a first compression protection element 146 and a further compression protection element 130 is arbitrarily referred to as a second compression protection element 148.

At least one of the compression protection elements 130, 146, 148 is in each case formed in a plurality of peripheral zone portions 270 which are successive along a peripheral direction of extent 260.

A compression protection element extent 268, able to be measured in the direction of the peripheral direction of extent 260, of the compression protection elements 130, 146, 148 is greater than a compression protection element spacing 266, able to be measured in the direction of the peripheral direction of extent 260, of in each case two adjacent compression protection elements 130, 146, 148 which are formed in successive peripheral zone portions 270.

The compression protection elements 130, 146, 148 are in each case formed so as to be encircling in an annular manner, e.g. circular, within the respective peripheral zone portion 270. One corrugation element 128 forms in each case one of the compression protection elements 130, thus also the first compression protection element 146 and the second compression protection element 148. The corrugation elements 128 are formed from a plate 100, e.g. from a separator plate 104.

The compression protection unit 118 shown in FIG. 40 defines a first elevation zone 234 and a second elevation zone 236. A zone of each compression protection element 130, 146, 148 that lies closer to the seal element not shown is a first elevation zone 234. A zone of each compression protection element 130, 146, 148 that lies farther away from the seal element not shown is a second elevation zone 236.

The section through one of the compression protection elements 130, 146, 148 that is shown in FIG. 41 shows that the compression protection unit 118 is raised in the first elevation zone 234 and in the second elevation zone 236 in the direction of the plate stack longitudinal axis 120 in comparison to a base portion 246 of the seal arrangement 114. The base portion 246 is between the seal element not shown and the compression protection unit 118. One corrugation element 128 defines in each case the two elevation zones 234, 236.

The compression protection unit 118 has in each case one intermediate portion 248 between the first elevation zone 234 and the second elevation zone 236. The intermediate portions 248 define in each case one intermediate elevation zone 242.

FIG. 41 shows that the intermediate portion 248 is raised in the respective intermediate elevation zone 242 in the direction of the plate stack longitudinal axis 120 in comparison to the base portion 246. The compression protection unit 118 is in each case raised more in the first elevation zone 234 and in the second elevation zone 236 in the direction of the plate stack longitudinal axis 120 than the intermediate portion 248. The intermediate height 252 of the compression protection unit 118, able to be measured so as to proceed from the intermediate portion 248 in the direction of the plate stack longitudinal axis 120, on the first elevation zone 234 is approximately 90% of the base height 250 of the compression protection unit 118, able to be measured so as to proceed from the base portion 246 in the direction of the plate stack longitudinal axis 120, on the same elevation zone 234.

FIG. 41 also shows that the corrugation element 128 has flanks 142 of different heights. A higher flank 142, which extends so as to proceed from the base portion 246, is of flatter inclination that a flank 142 which is of lesser height and extends so as to proceed from the intermediate portion 248. An inclination angle 254 of the higher flank 142 of flatter inclination can be, for example, by approx. 10° to approx. 25° smaller than a larger inclination angle 256 of the flank 142 of lesser height and steeper inclination, as is indicated by way of example in FIG. 41.

The plate 100, e.g. the separator plate 104, has two interconnected plate elements 136, wherein a main surface 138 of the one plate element 136 faces a main surface 138 of the other plate element 136. One of the plate elements 136 faces away from the observer in FIG. 40. A seal arrangement 114 is formed on the one plate element 136 that faces the observer. The further seal arrangement 114 is formed on the other plate element 136 that faces away from the observer. Of the further seal arrangement 114, only a compression protection element 130 of a further compression protection unit 118 is indicated with dashed lines in FIG. 40. The compression protection elements 130 of the further compression protection unit 118 that faces away from the observer can be disposed next to one another, for example, as is shown for the compression protection unit 118 that faces the observer in FIG. 40. A first compression protection unit portion 184 of the one compression protection unit 118 overlaps a first compression protection unit portion 186 of the further compression protection unit 118. A second compression protection unit portion 190 of the one compression protection unit 118 does not overlap a second compression protection unit portion 192 of the further compression protection unit 118.

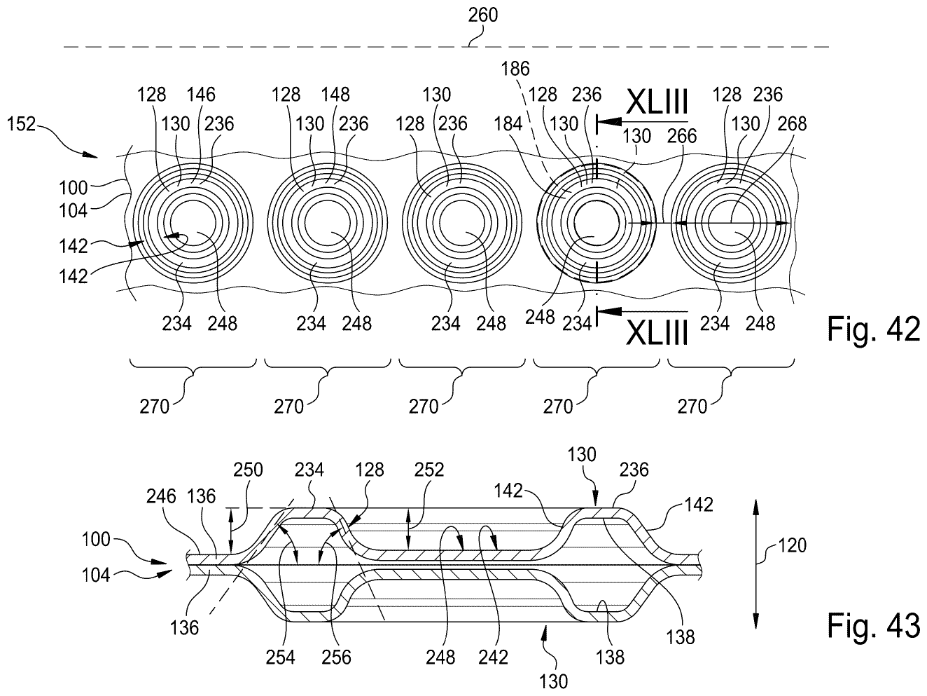

A small fragment of a seal arrangement 114 is also shown in FIG. 42. The seal arrangement 114 comprises a compression protection unit 118 for protecting a seal element 116, not illustrated in the small fragment, of the seal arrangement 114 from irreversible deformation during compression of a plate stack arrangement along a plate stack longitudinal axis. The plate 100, e.g. the separator plate 104, shown in FIG. 42 also has two interconnected plate elements 136, wherein a main surface 138 of the one plate element 136 faces a main surface 138 of the other plate element 136. One of the plate elements 136 faces away from the observer in FIG. 42. This also becomes clear from the section shown in FIG. 43. A seal arrangement 114 is formed on the one plate element 136 that faces the observer. The further seal arrangement 114 is formed on the other plate element 136 that faces away from the observer. Of the further seal arrangement 114, only a compression protection element 130 of a further compression protection unit 118 is indicated with dashed lines in FIG. 42. The compression protection elements 130 of the further compression protection unit 118 that faces away from the observer can be disposed next to one another, for example, as is shown for the compression protection unit 118 that faces the observer in FIG. 42. A first compression protection unit portion 184 of the one compression protection unit 118 overlaps a first compression protection unit portion 186 of the further compression protection unit 118. As opposed to the arrangement shown in FIGS. 40 and 41, the compression protection elements 130 of both compression protection units 118 lie so as to be congruent on top of one another.

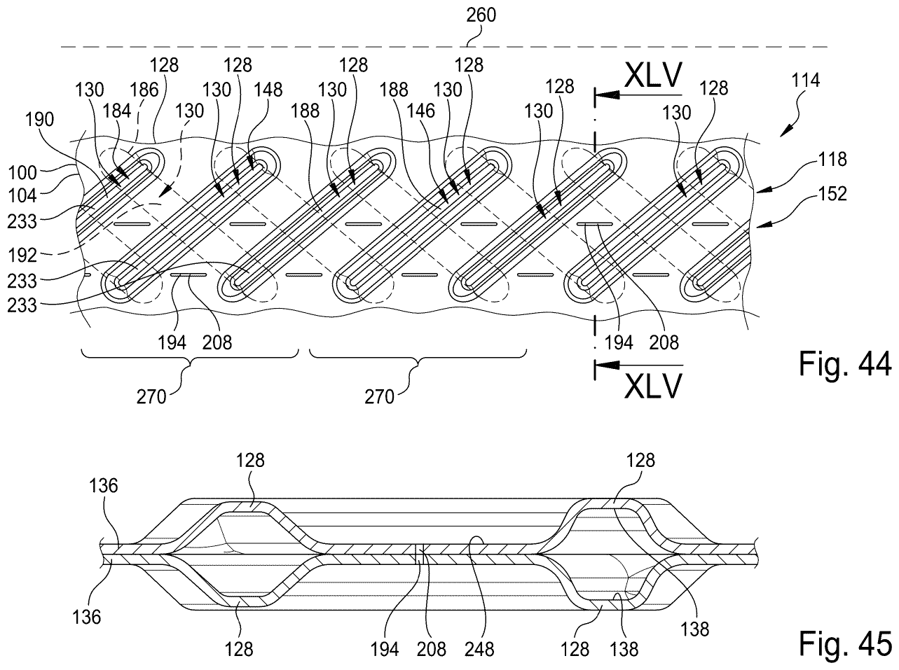

Only a small fragment of a seal arrangement 114 is shown in FIG. 44. The seal arrangement 114 comprises a compression protection unit 118 for protecting a seal element 116, not illustrated in the small fragment, of the seal arrangement 114 from irreversible deformation during compression of a plate stack arrangement along a plate stack longitudinal axis.

The compression protection unit 118 has many compression protection elements 130, of which a compression protection element 130 is arbitrarily referred to in FIG. 44 as a first compression protection element 146 and a further compression protection element 130 is arbitrarily referred to as a second compression protection element 148.

At least one of the compression protection elements 130 is in each case formed in a plurality of peripheral zone portions 270 which are successive along a peripheral direction of extent 260. Thus, the first compression protection element 146 is formed in one peripheral zone portion 270, and the second compression protection element 148 is formed in an adjacent peripheral zone portion 270. Therebetween lies a further compression protection element which extends from one peripheral zone portion 270 into an adjacent peripheral zone portion 270.

The plate 100, e.g. the separator plate 104, shown in FIG. 44 also has two interconnected plate elements 136, wherein a main surface 138 of the one plate element 136 faces a main surface 138 of the other plate element 136. One of the plate elements 136 faces away from the observer in FIG. 44. This also becomes clear from the section shown in FIG. 45. A seal arrangement 114 is formed on the one plate element 136 that faces the observer. The further seal arrangement 114 is formed on the other plate element 136 that faces away from the observer. Of the further seal arrangement 114, the compression protection element 130 of a further compression protection unit 118 is indicated with dashed lines. The compression protection elements 130 of the further compression protection unit 118 that faces away from the observer are formed in peripheral zone portions 270 as is shown for the compression protection unit 118 that faces the observer in FIG. 44. A first compression protection unit portion 184 of the one compression protection unit 118 overlaps a first compression protection unit portion 186 of the further compression protection unit 118. A second compression protection unit portion 190 of the one compression protection unit 118 does not overlap a second compression protection unit portion 192 of the further compression protection unit 118.

FIGS. 44 and 45 show connections 194 of the plate elements 136 in the peripheral zone 152 of the seal arrangement 114.

FIG. 44 shows that the two compression protection units 118 define elevation zones 233. The connections 194 exist within both compression protection units 118, in each case between the different elevation zones 233. The compression protection elements 130, 146, 148 are corrugation elements 128, wherein one corrugation element defines in each case one elevation zone 233.

The connections 194 have welding zones 208. The plate elements 136 are welded to one another in the welding zones 208.

The connections 194 of the plate elements 136 exist between two overlap zones 188 which are mutually offset in the plate plane, wherein different compression protection unit portions of different compression protection units 118, formed in each case from one of the two plate elements 136, overlap one another in the overlap zones 188. The compression protection elements 130, 146, 148 of both plate elements 136 represents compression protection unit portions.

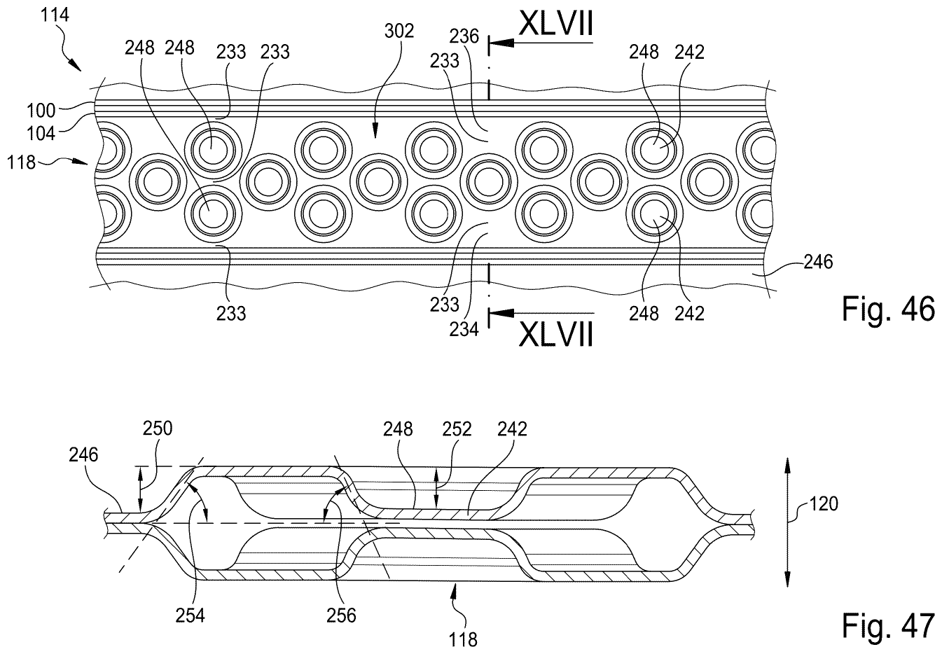

A small fragment of a seal arrangement 114 is shown in FIG. 46. This fragment shows only a part of the compression protection unit 118 comprised by the seal arrangement 114. The compression protection unit 118 defines a multiplicity of elevation zones 233. The compression protection unit 118 has intermediate portions 248.

Elevation zones which lie in each case opposite an intermediate portion 248 can be considered to be a first elevation zone 234 and to be a second elevation zone 236, as is indicated by way of example for two of the elevation zones 233 in FIG. 46.

The compression protection unit 118 is raised in the first elevation zone 234 and in the second elevation zone 236 in the direction of the plate stack longitudinal axis 120 in comparison to a base portion 246 of the seal arrangement 114. The base portion 246 is between the seal element 116, which is not illustrated in FIG. 46, and the compression protection unit 118.

The intermediate portions 248 define intermediate elevation zones 242 in which the intermediate portion 248 is raised in the direction of the plate stack longitudinal axis 120 in comparison to the base portion 246, wherein the compression protection unit 118 in a plateau zone 302 is in each case raised more in the direction of the plate stack longitudinal axis 120 than in the intermediate portions 248. This is shown in FIG. 47 in which a section through FIG. 46 along the line XLVII-XLVII is illustrated, by way of example for one of the intermediate portions 248.

The elevation zones 233, 234, 236 transition into one another and form the plateau zone 302 extending about a plurality of intermediate portions 248 which are recessed into the plateau zone 302.

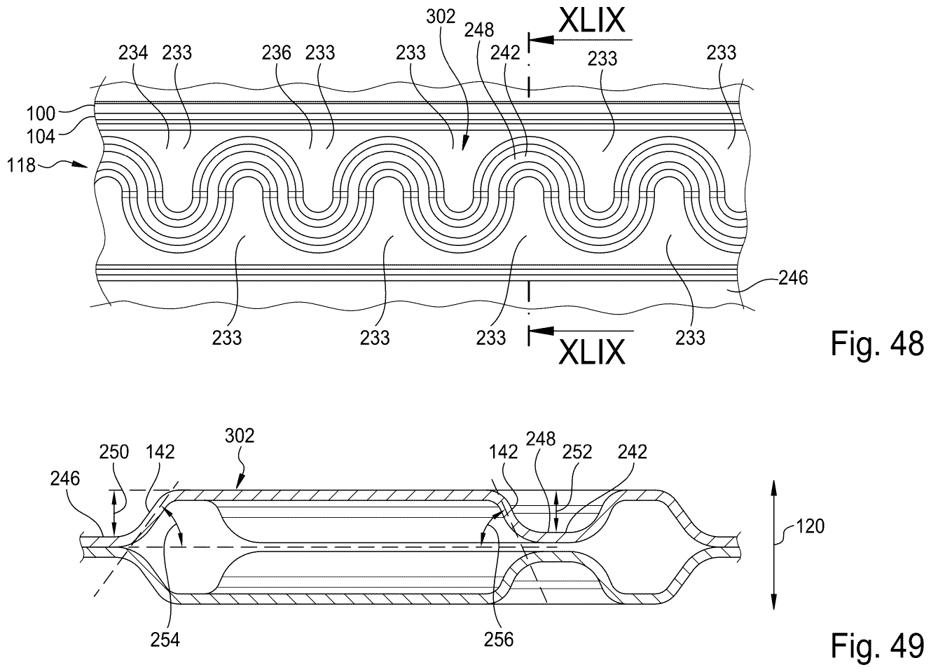

A small fragment of a seal arrangement 114 is shown in FIG. 48. This fragment only shows a part of the compression protection unit 118 comprised by the seal arrangement 114.

The compression protection unit 118 shown there has a plateau zone 302 which is raised in comparison to the base portion 246 of the seal arrangement 114. The plateau zone 302 is formed by elevation zones 233, 234, 236 that transition into one another. The plateau zone 302 extends about an intermediate portion 248 which is recessed into the plateau zone 302. The intermediate portion 248 defines an intermediate elevation zone 242 in which the intermediate portion 248 is raised in the direction of the plate stack longitudinal axis 120 in comparison to the base portion 246.

The compression protection unit 118 is raised more in the plateau zone 302 in the direction of the plate stack longitudinal axis 120 than the intermediate portion 248 which is recessed into the plateau zone 302. The intermediate portion 248 shown in FIG. 48 is an intermediate portion 248 which extends in a meandering manner and is recessed into the plateau zone 302.

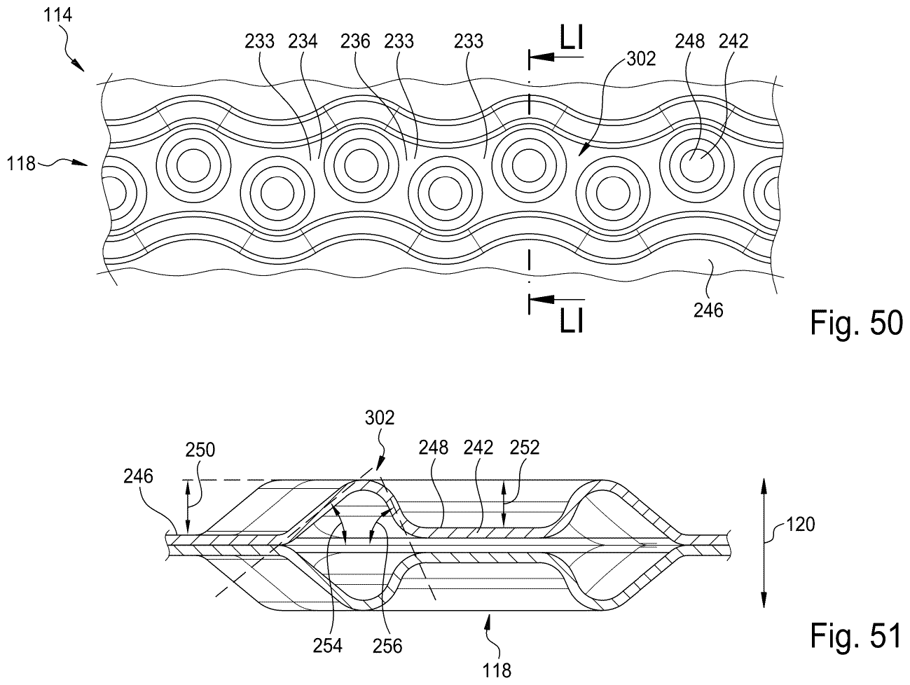

A small fragment of a seal arrangement 114 is also shown in FIG. 50. This fragment only shows a part of the compression protection unit 118 comprised by the seal arrangement 114. As opposed to the seal arrangement from FIG. 48, a multiplicity of recessed intermediate portions 248 are provided, each being intermediate elevation zones 242.

It becomes clear from the sections illustrated in FIGS. 47, 49 and 51 that an intermediate height 252 of the compression protection unit 118, able to be measured so as to proceed from the respective intermediate portion 248 in the direction of the plate stack longitudinal axis 120, on the plateau zone 302 is approximately 80% to 90% of a base height 250 of the compression protection unit 118, able to be measured so as to proceed from the base portion 246 in the direction of the plate stack longitudinal axis 120, on the plateau zone 302.

It also becomes clear from the sections illustrated in FIGS. 47, 49 and 51 that the plateau zone 302 has flanks 142 of different heights. A higher flank 142 which extends so as to proceed from the base portion 246, is of flatter inclination than a flank 142 which is of lesser height and extends so as to proceed from the intermediate portion 248.

List of reference signs

| | |
|---|---|
| 100 | Plate |
| 101 | Space |
| 102 | Plate stack arrangement |
| 103 | Plate intermediate space |
| 104 | Separator plate |
| 105 | Conduit space |
| 106 | Fuel cell stack |
| 108 | Metal plate |
| 110 | Bipolar plate |
| 112 | Flux field |
| 114 | Seal arrangement |
| 116 | Seal element |
| 118 | Compression protection unit |
| 120 | Plate stack longitudinal axis |
| 122 | Seal corrugation |
| 124 | Full corrugation |
| 125 | Port corrugation |
| 126 | Perimeter corrugation |
| 128, 129 | Corrugation element |
| 130 | Compression protection element |
| 134 | Stud |
| 136 | Plate element |
| 138 | Main surface |
| 140 | Wall |
| 141 | Region |
| 142 | Flank |
| 144 | Leg |
| 146 | First compression protection element |
| 148 | Second compression protection element |
| 150 | Third compression protection element |
| 152 | Peripheral zone |
| 154 | Periphery |
| 155 | Separator plate element |
| 156 | Metal plate element |
| 158 | Bipolar plate element |
| 160, 162 | Surface |
| 164 | Absorption material |
| 166, 226 | Depression |
| 168 | Wider seal element portion |
| 170 | Narrower seal element portion |
| 172 | Wider sealing corrugation portion |
| 174 | Narrower sealing corrugation portion |
| 176 | Wider compression protection unit portion |
| 178 | Narrower compression protection unit portion |
| 180 | Wider corrugation element portion |
| 182 | Narrower corrugation element portion |
| 184, 186 | First compression protection unit portion |
| 188 | Overlap zone |
| 190, 192 | Second compression protection unit portion |
| 194 | Connection |
| 196 | Compression protection zone |
| 198 | First layer |
| 200 | Second layer |
| 201 | Material |
| 202 | Filler material |
| 204, 206 | Portion |
| 208 | Welding zone |
| 210 | Spacing |
| 212 | Extent |
| 214 | Plate intermediate product |
| 216 | Precursor extent |
| 218 | Corrugation precursor element |
| 220 | Elevation element |
| 222 | Depression element |
| 224 | Elevation |
| 226 | Depression |
| 228 | Elevation height |
| 230 | Depression depth |
| 232 | Insulation |
| 234 | First elevation zone |
| 236 | Second elevation zone |
| 238 | Intermediate zone |
| 240 | Intermediate connection zone |
| 242 | Intermediate elevation zone |
| 246 | Base portion |
| 248 | Intermediate portion |
| 250 | Base height |
| 252 | Intermediate height |
| 254 | Smaller inclination angle |
| 256 | Larger inclination angle |
| 258 | Compression protection unit direction of extent |
| 260 | Peripheral direction of extent |
| 262 | Angle of extent |
| 264 | Seal element direction of extent |
| 266 | Compression protection element spacing |
| 268 | Compression protection element extent |
| 270 | Peripheral zone portion |
| 272 | Inner peripheral zone |
| 274 | Outer peripheral zone |
| 276 | Outer end |
| 278 | Inner end |
| 280 | First base height |
| 282 | Second base height |
| 284 | Third base height |
| 286 | Body elevation zone |
| 288 | Head elevation zone |
| 290 | Lower compression protection unit portion |
| 292 | Higher compression protection unit portion |
| 294 | Direction of extent of the compression protection unit |
| 296 | Body height |
| 298 | Overall height |
| 300 | Counter-elevation zone |
| 302 | Plateau zone |

1. A seal arrangement for sealing a space in a plate stack arrangement, wherein the seal arrangement comprises the following:
a seal element for delimiting the space in at least one direction, and
a compression protection unit for protecting the seal element in relation to irreversible deformation during compression of the plate stack arrangement along a plate stack longitudinal axis.

2. The seal arrangement as claimed in claim 1,
wherein the seal element has a seal corrugation.

3. The seal arrangement as claimed in claim 1,
wherein the compression protection unit has a first compression protection element and a second compression protection element,
and/or
wherein the compression protection unit has
a corrugation element; and/or
a multi-layer compression protection zone; and/or
an elevation element and a depression element, wherein part of an elevation of the elevation element is received in a depression of the depression element,
and/or
wherein the compression protection unit has the corrugation element, and the corrugation element is formed from a plate of the plate stack arrangement.

4. The seal arrangement as claimed in claim 1,
wherein
at least one compression protection unit, or at least part or at least one portion of the at least one compression protection unit, is disposed or formed in a peripheral zone, wherein the peripheral zone extends from the seal element to a periphery delimiting the surface extent of a plate of the plate stack arrangement.

5. The seal arrangement as claimed in claim 3,
wherein the corrugation element forms at least one of the two compression protection elements,
and/or
wherein the first compression protection element and the second compression protection element are formed and/or disposed such that during compression of the plate stack arrangement along the plate stack longitudinal axis, compression of the first compression protection element sets in before compression of the second compression protection element,
and/or
wherein the first compression protection element and the second compression protection element are formed such that during compression of the plate stack arrangement along the plate stack longitudinal axis, compression of the second compression protection element requires a higher input of force and/or energy than compression of the first compression protection element,
and/or
wherein the first compression protection element and the second compression protection element are formed such that during compression of the plate stack arrangement along the plate stack longitudinal axis, compression of at least the first compression protection element sets in before an irreversible deformation of the seal element occurs,
and/or
wherein the corrugation element forms at least one of a plurality of compression protection elements, and an absorption material disposed on a surface of the corrugation element forms a further one of a plurality of compression protection elements,
and/or
wherein a depression is formed in a wall of the corrugation element, wherein the depression can be formed in the same direction of the corrugation element or counter thereto.

6. The seal arrangement as claimed in claim 1,
wherein
the seal element has at least one wider and at least one narrower seal element portion, wherein a width of the seal element in the wider seal element portion is larger than a width of the seal element in the narrower seal element portion;
and/or
the compression protection unit has at least one wider and at least one narrower compression protection unit portion, wherein a width of the compression protection unit in the wider compression protection unit portion is larger than a width of the compression protection unit in the narrower compression protection unit portion;
and/or
the seal element has at least one higher and at least one lower seal element portion, wherein a height of the seal element in the higher seal element portion is larger than a width of the seal element in the lower seal element portion;
and/or
the compression protection unit has at least one higher and at least one lower compression protection unit portion, wherein a height of the compression protection unit in the higher compression protection unit portion is larger than a height of the compression protection unit in the lower compression protection unit portion.

7. The seal arrangement as claimed in claim 4,
wherein
the compression protection unit has the multi-layer compression protection zone,
wherein at least one portion of the multi-layer compression protection zone is disposed or formed in the peripheral zone,
wherein a first and a second layer of the multi-layer compression protection zone are formed by the same plate, wherein both layers extend so as to proceed from the periphery that delimits the surface extent of the plate, and/or
wherein the seal corrugation is formed from a first one of the two layers, and the second one of the two layers extends from the periphery in the direction toward the seal corrugation.

8. The seal arrangement as claimed in claim 7,
wherein
a multi-layer compression protection zone is formed on one portion of the periphery, and no multi-layer compression protection zone is formed on another portion of the periphery
and/or
one portion of the multi-layer compression protection zone is wider than another portion of the multi-layer compression protection zone, wherein in the wider portion of the multi-layer compression protection zone the second one of the layers extends further away from the periphery in the direction toward the seal element than in the other portion of the multi-layer compression protection zone, and/or
wherein the wider portion or the other portion of the multi-layer compression protection zone forms the first compression protection element.

9. The seal arrangement as claimed in claim 3,
wherein
the compression protection unit has the elevation element and the depression element, wherein part of an elevation of the elevation element is received in a depression of the depression element, wherein the elevation element and the depression element can in each case be a corrugation element, and/or
wherein
an elevation height of the elevation is larger than a depression depth of the depression,
and/or
flanks of the elevation in the depression are spaced apart from flanks of the depression, wherein the flanks of the elevation in the depression can be spaced apart from flanks of the depression wherein the flanks of the elevation can spread toward the flanks of the depression.

10. The seal arrangement as claimed in claim 1,
wherein
the compression protection unit defines a first elevation zone and a second elevation zone,
wherein the compression protection unit in the first elevation zone and in the second elevation zone is raised in the direction of the plate stack longitudinal axis in comparison to a base portion of the seal arrangement,
and/or
wherein the compression protection unit has the corrugation element and the corrugation element defines at least one of the two elevation zones, wherein a further corrugation element, or the same corrugation element, can define a further one of the two elevation zones.

11. The seal arrangement as claimed in claim 10,
wherein the compression protection unit has a plateau zone which is raised in comparison to a base portion of the seal arrangement
and/or
wherein the compression protection unit has an intermediate portion between the first elevation zone and the second elevation zone, and/or the plateau zone extends about an intermediate portion recessed into the plateau zone or about a plurality of intermediate portions recessed into the plateau zone, wherein
the compression protection unit in the intermediate portion is not raised in the direction of the plate stack longitudinal axis in comparison to the base portion,
or
the intermediate portion defines an intermediate elevation zone in which the intermediate portion is raised in the direction of the plate stack longitudinal axis in comparison to the base portion, wherein the compression protection unit in the first elevation zone and in the second elevation zone is in each case raised more in the direction of the plate stack longitudinal axis than the intermediate portion, or wherein the compression protection unit in the plateau zone is raised more in the direction of the plate stack longitudinal axis than the intermediate portion recessed into the plateau zone, or than the intermediate portions recessed into the plateau zone.

12. The seal arrangement as claimed in claim 11,
wherein
an intermediate height of the compression protection unit, able to be measured proceeding from the intermediate portion in the direction of the plate stack longitudinal axis, on the first or the second elevation zone or on the plateau zone is 10% to 99.8% or 50% to 99% or 75% to 98% of a base height of the compression protection unit, able to be measured proceeding from the base portion in the direction of the plate stack longitudinal axis, on the same elevation zone or plateau zone.

13. The seal arrangement as claimed in claim 3,
wherein
the corrugation element has flanks of different heights, the corrugation elements have flanks of different heights, or the plateau zone has flanks of different heights,
wherein the number of flanks is at least four,
wherein a higher flank, extending so as to proceed from the base portion, is flatter in inclination than a flank of lesser height, extending so as to proceed from the intermediate portion, and/or wherein a smaller inclination angle of the higher flank flatter in inclination is 15° to 70°, and a larger inclination angle of the flank of lesser height and steeper in inclination is 20° to 90°.

14. The seal arrangement as claimed in claim 1,
wherein
a compression protection unit direction of extent, along which at least one part of a compression protection unit extends, has in relation to a seal element direction of extent, along which a part of the seal element that is directly adjacent to the at least one part of the compression protection unit extends, an angle of extent in a range from 5° to 85° or 20° to 70°.

15. The seal arrangement as claimed in claim 4,
wherein
the compression protection unit has a first compression protection element and a second compression protection element, and the two compression protection elements are disposed or formed in the peripheral zone,
wherein at least a first one of the compression protection elements is disposed or formed completely in a peripheral zone portion of the peripheral zone,
wherein the peripheral zone portion extends in the radial direction from the seal element up to the periphery, and the peripheral zone portion extends along a peripheral direction of extent over a length of at most 15% of the peripheral length,
wherein the peripheral length is a length of the periphery, and/or
wherein at least one of the compression protection elements is formed to be encircling in an annular manner within the peripheral zone portion.

16. The seal arrangement as claimed in claim 15,
wherein
at least one compression protection element is in each case disposed or formed in a plurality of successive peripheral zone portions along the peripheral direction of extent, and/or
wherein a compression protection element extent of at least one of the compression protection elements, able to be measured in the direction of the peripheral direction of extent, is larger than a compression element protection element spacing of two adjacent compression protection elements, able to be measured in the direction of the peripheral direction of extent, that are disposed or formed in successive peripheral zone portions.

17. The seal arrangement as claimed in claim 4,
wherein
at least two compression protection elements are disposed or formed in the peripheral zone,
wherein a first one of the at least two compression protection elements lies in the peripheral zone so as to be farther from the periphery than a second one of the at least two compression protection elements, and/or
wherein
an outer end of the compression protection element lying in the peripheral zone so as to be farther from the periphery lies farther from the periphery than an inner end of the second one of the at least two compression protection elements;
and/or
one compression protection element is in each case disposed or formed on the inside in the peripheral zone in a plurality of successive peripheral zone portions along the peripheral direction of extent, and another compression protection element is disposed or formed on the outside in the peripheral zone;
and/or
the peripheral zone comprises an outer peripheral zone which is closer to the periphery, and an inner peripheral zone which is farther from the periphery, a plurality of compression protection elements which are adjacent in the direction of the peripheral direction of extent being disposed or formed in the outer peripheral zone, and a plurality of compression protection elements which are adjacent in the peripheral direction of extent being disposed or formed in the inner peripheral zone; and/or
wherein at least one of the compression protection elements is a corrugation element or a plurality of the compression protection elements are corrugation elements or all compression protection elements are corrugation elements.

18. The seal arrangement as claimed in claim 10,
wherein
the compression protection unit in comparison to the base portion of the seal arrangement is raised in the direction of the plate stack longitudinal axis to a lesser extent in the first elevation zone than in the second elevation zone,
wherein at least the first one of the at least two compression protection elements is a corrugation element, and at least the second one of the at least two compression protection elements is a corrugation element,
and/or
wherein the first elevation zone is a body elevation zone, and the second elevation zone is a head elevation zone which adjoins the body elevation zone in the direction of the plate stack longitudinal axis.

19. The seal arrangement as claimed in claim 1,
wherein the compression protection unit has at least one higher and at least one lower compression protection unit portion, wherein a height of the compression protection unit in the higher compression protection unit portion is larger than a height of the compression protection unit in the lower compression protection unit portion,
and/or
wherein a degree of bending of the compression protection unit along a direction of extent of the compression protection unit, increases and decreases in alternation
and/or
wherein
the compression protection unit has the elevation element and the depression element, wherein part of an elevation of the elevation element is received in a depression of the depression element;
and/or
the compression protection unit has an elevation element and a depression element, wherein part of an elevation of the elevation element is able to be received in a depression of the depression element when a deformation of the compression protection unit occurs during compression of the plate stack arrangement along a plate stack longitudinal axis.

20. The seal arrangement as claimed in claim 19,
wherein at least part of the elevation element and at least part of the depression element are formed between corrugation elements.

21. A plate stack arrangement comprising:
a plurality of plates,
a space in the plate stack arrangement, and
a seal arrangement as claimed in claim 1, the seal element of the latter delimiting the space in at least one direction.

22. The plate stack arrangement as claimed in claim 21,
wherein
the compression protection unit has two compression protection sub-units, and at least one of the two compression protection sub-units rises from a plate plane of at least one of the two plates in the direction toward the other compression protection sub-unit, or into the other compression protection sub-unit,
and/or
wherein the plate stack arrangement comprises the following:
a further space in the plate stack arrangement, and
a further seal arrangement, the seal element of the latter delimiting the further space in at least one direction,
and/or wherein at least one plate of the plate stack arrangement has two plate elements which are connected indirectly or directly to one another, wherein a main surface of the one plate element faces a main surface of the other plate element.

23. The plate stack arrangement as claimed in claim 22,
wherein
there is an indirect or direct connection of the plate elements in the peripheral zone of a seal arrangement
between the seal element and the compression protection unit of the seal arrangement;
and/or
between the compression protection unit and the periphery;
and/or
within the compression protection unit,
and/or
wherein the further seal arrangement is a further seal arrangement as claimed in claim 1,
wherein at least one first compression protection unit portion of the one compression protection unit overlaps a first compression protection unit portion of the further compression protection unit,
wherein at least one second compression protection unit portion of the one compression protection unit does not overlap a second compression protection unit portion of the further compression protection unit.

24. The plate stack arrangement as claimed in claim 23,
wherein the two compression protection unit portions of the one compression protection unit are formed from the one of the interconnected plate elements, and the two compression protection unit portions of the further compression protection unit are formed from the other one of the interconnected plate elements,
and/or
wherein there is an indirect or direct connection of the plate elements between two overlap zones which are mutually offset in the plate plane, wherein different compression protection units or compression protection unit portions of different compression protection units formed in each case from one of the two plate elements overlap one another in the overlap zones.

25. The plate stack arrangement as claimed in claim 22,
wherein
a spacing of a compression protection unit from a nearest location at which there is an indirect or direct connection of the plate elements is at most 200% of a greatest extent of the compression protection unit in the direction of the plate stack longitudinal axis,
wherein a spacing of a corrugation element, elevation element or depression element formed from at least one of the plate elements from a nearest location at which there is an indirect or direct connection of the plate elements can be at most 200% of the depth of the depression element, or at most 200% of the height of the corrugation element or of the elevation element.
